(19) United States
(12) Patent Application Publication
(10) Pub. No.: US 2011/0289913 A1
(43) Pub. Date: Dec. 1, 2011

(54) WAVE ENERGY TRANSFER SYSTEM

(76) Inventors: Kenneth W. Welch, JR., Willis, TX (US); William P. Forester, Minneapolis, MN (US)

(21) Appl. No.: 13/117,841

(22) Filed: May 27, 2011

Related U.S. Application Data
(60) Provisional application No. 61/349,730, filed on May 28, 2010.

(51) Int. Cl. F03B 17/02

(52) U.S. Cl. 60/495

(57) ABSTRACT

A system and method of wave energy transfer including the generation and capture of waves in a tank filled with liquid is disclosed. The wave energy transfer system comprises wave generation apparatus including a displacement block for generating the waves in the tank, and wave capture apparatus including a buoyancy block for capturing the waves to convert the wave motion and provide fluid flow. The wave capture apparatus may also include an artificial pump head for stabilizing the fluid flow provided by the buoyancy block of the wave capture apparatus. Testing apparatus including a tank filled with liquid and wave generation devices is also disclosed.

### CROSS-REFERENCE TO RELATED APPLICATIONS

This application claims the benefit of U.S. Provisional Application No. 61/349,730, filed May 28, 2010, incorporated by reference.

### BACKGROUND OF THE PRESENT INVENTION

The present disclosure relates generally to utilizing the potential energy of wave energy, and more particularly, but not by way of limitation, to a wave energy transfer system including the generation and capture of wave energy.

There have been many attempts to harness what is commonly referred to as wave phenomena and to translate energy observed in wave phenomena into usable, reliable energy sources. Wave phenomena involves the transmission of energy and momentum by means of vibratory impulses through various states of matter, and in the case of electromagnetic waves for example, through a vacuum. Theoretically, the medium itself does not move as the energy passes through. The particles that make up the medium simply move in a translational or angular (orbital) pattern transmitting energy from one to another. Waves, such as those on an ocean surface, have particle movements that are neither longitudinal nor transverse. Rather, movement of particles in the wave typically involve components of both longitudinal and transverse waves. Longitudinal waves typically involve particles moving back and forth in a direction of energy transmission. These waves transmit energy through all states of matter. Transverse waves typically involve particles moving back and forth at right angles to the direction of energy transmission. In an orbital wave, particles move in an orbital path. These waves transmit energy along an interface between two fluids (liquids or gases).

There have been many attempts to harness and utilize energy produced by wave phenomena going back to the turn of the last century, such as the system disclosed in U.S. Pat. No 597,833, issued Jan. 25, 1898. These attempts have included erecting a sea wall to capture energy derived from the wave phenomena; utilizing track and rail systems involving complex machinations to harness energy from wave phenomena; development of pump systems that are adapted only for shallow water wave systems; and construction of towers and the like near the sea shore where the ebb and flow of the tide occurs. Still other attempts have been made as well which are not described in detail herein.

Each of these systems is replete with problems. For example, certain systems which are adapted for sea water use are subjected accordingly to the harsh environment. These systems involve numerous mechanical parts which require constant maintenance and replacement, and therefore make the system undesirable. Other systems are limited to construction only at sea shore or in shallow water, which limit placement of the systems and therefore make the systems undesirable. Finally, other systems fail to use the full energy provided by the wave phenomena, and therefore waste energy through collection, resulting in an inefficient system.

Depletions in traditional energy sources, such as oil, have required the need for an efficient alternate sources of energy. The greenhouse gas effect, which is believed to be the cause for such phenomena as global warming and the like, further establish the need for an environment-friendly energy harnessing systems. The decline in readily available traditional fuel sources has lead to an increase in the costs of energy, which has a global economic impact. This adds yet another need for the creation of an environment-friendly, high efficiency, low cost energy device.

The need for readily available, cheaper sources of energy are also keenly felt around the world. In places such as China for example, rivers are being dammed up to create a large energy supply for a fast growing population. Such projects can take twenty or more years to finish. The availability of the energy created by such a damming project does not begin until final completion of the project. Accordingly, there is yet another need for an energy device which has a short construction period, generates energy as construction phases are completed, and then provides energy to the grid.

### SUMMARY OF THE INVENTION

According to one illustrative embodiment, a wave generation system is presented. The wave generation system includes a transfer arm pivotally attached to a base to allow pivotal movement of the transfer arm between an engaged position and a disengaged position. The transfer arm has a first end and a second end. The wave generation system further includes a displacement block coupled to the first end of the transfer arm, a first spring member operably associated with the transfer arm to exert a first force on the transfer arm; and a second spring member operably associated with the transfer arm to exert a second force on the transfer arm. The first force is substantially opposite in direction to the second force. An input source is also operably associated with the transfer arm to move the transfer arm between the engaged position and the disengaged position. In a possible modification of this embodiment, the displacement block could be replaced by an alternate load, i.e., lifting a crate or the crushing of garbage, to create a heavy lifting device.

According to another illustrative embodiment, an energy transfer system is presented. The energy transfer system includes a wave generation apparatus and a wave capture apparatus. The wave generation apparatus includes an elongated arm pivotally attached to a base to allow pivotal movement of the elongated arm between an engaged position and a disengaged position. The elongated arm has a first end and a second end. The wave generation apparatus further includes a displacement block coupled to the first end of the elongated arm to permit at least partial submersion of the displacement block in a body of water when the elongated arm is in the engaged position, such that the at least partial submersion of the displacement block generates a wave in the body of water. A first spring member is operably associated with the elongated arm to exert a first force on the elongated arm and a second spring member is operably associated with the elongated arm to exert a second force on the elongated arm. The first force is substantially opposite in direction to the second force. An input source is operably associated with the elongated arm to move the elongated arm between the engaged position and the disengaged position. The wave capture apparatus includes a buoyancy block operable to reciprocally move in response to the wave to move an operating fluid using the energy of the wave.

In yet another illustrative embodiment, a wave testing apparatus is presented. The wave testing apparatus includes a tank configured to hold a liquid and a wave generation apparatus. The wave generation apparatus includes an elongated arm pivotally attached to a base to allow pivotal movement of the elongated arm between an engaged position and a disengaged position. The elongated arm has a first end and a second end. The wave generation apparatus further includes a displacement block coupled to the first end of the elongated arm to permit at least partial submersion of the displacement block in the liquid when the elongated arm is in the engaged position such that the at least partial submersion of the displacement block generates a wave in the liquid. A first spring member is operably associated with the elongated arm to exert a first force on the elongated arm and a second spring member is operably associated with the elongated arm to exert a second force on the elongated arm. The first force is substantially opposite in direction to the second force. An input source is operably associated with the elongated arm to move the elongated arm between the engaged position and the disengaged position. The waves created through the oscillation of the displacement block as the transfer arm moves from the engaged position and back may be utilized to examine the effects of certain waves upon structures designed to operate in an environment with fluid waves.

In still another illustrative embodiment, a buoyancy pump system is presented. The buoyancy pump system includes a buoyancy block operable to reciprocally move in response to wave action and a transfer arm pivotally attached to a base to allow pivotal movement of the transfer arm between a first position and a second position. The transfer arm has a first end and a second end. The first end is coupled to the buoyancy block such that movement of the transfer arm between the first position and the second position is in response to movement of the buoyancy block. The buoyancy pump system further includes a first spring member operably associated with the transfer arm to exert a first force on the transfer arm and a second spring member operably associated with the transfer arm to exert a second force on the transfer arm. The first force is substantially opposite in direction to the second force. A piston is slidably disposed within a piston cylinder and connected to the second end of the transfer arm. The piston is reciprocally moveable in a first direction and a second direction such that when the piston moves in the second direction an operating fluid is drawn into the piston cylinder and when the piston moves in the first direction the operating fluid is forced out of the piston cylinder.

According to yet another illustrative embodiment, a buoyancy pump system is presented. The buoyancy pump system includes a buoyancy block operable to reciprocally move in response to wave action and a piston slidably disposed within a piston cylinder and connected to the buoyancy block. The piston reciprocally moves in a first direction and a second direction, such that when the piston moves in the second direction an operating fluid is drawn into the piston cylinder and when a piston moves in the first direction the operating fluid is forced out of the piston cylinder. The buoyancy pump system may further includes an artificial head apparatus having a chamber partially filled with the operating fluid and partially filled with a gas at a desired head pressure. The chamber may be fluidly connected to the piston cylinder to receive operating fluid that is forced from the piston cylinder.

According to another illustrative embodiment, a method of transferring energy from a first location to a second location is presented. The method includes artificially generating a wave at the first location and harnessing energy from the wave at the second location.

According to yet another illustrative embodiment, an artificial pump head may be utilized to stabilize the fluid flow of a buoyancy powered pump and/or store the energy harvested for later use. An artificial pump head includes a pressure vessel in which a gas fills a portion of the volume and a fluid fills a portion of the volume, and an inlet/outlet fluidly connected to the fluid stored within the pressure vessel. By filling the tank with fluid and/or pressurizing the gas, it is possible to store energy for later use and release it on demand.

Other features and advantages of the illustrative embodiments will become apparent with reference to the drawings and detailed description that follow.

### BRIEF DESCRIPTION OF THE DRAWINGS

FIG. 1 is a schematic, perspective view of an illustrative embodiment of an energy transfer system disposed in a land-based tank which includes a wave generation system;

FIGS. 1A-1C are schematic illustrations of three different wave patterns generated by the wave generation system of FIG. 1;

FIG. 2 is a schematic, perspective view of an illustrative embodiment of the wave generation system of FIG. 1;

FIGS. 2A and 2C are schematic, perspective views of illustrative embodiments of a pivotal connection of the wave generation system of FIG. 2;

FIGS. 2B and 2D are schematic, side views of illustrative embodiments of the pivotal connections of FIGS. 2A and 2C, respectively.

FIG. 3 is a schematic, perspective view of an other illustrative embodiment of the wave generation system of FIG. 1;

FIGS. 3A and 3B are schematic, perspective views of illustrative embodiments of a pivotal connection of the wave generation system of FIG. 3;

FIG. 4A is a schematic, perspective view of an illustrative embodiment of a displacement block for use in the wave generation system of FIG. 1;

FIG. 4B is a schematic, perspective view of another illustrative embodiment of a displacement block for use in the wave generation system of FIG. 1;

FIG. 5A is an schematic, perspective view of another illustrative embodiment of a displacement block for use in the wave generation system of FIG. 1;

FIG. 5B is an schematic, perspective view of another illustrative embodiment of a displacement block for use in the wave generation system of FIG. 1;

FIG. 5C is an schematic, perspective view of another illustrative embodiment of a displacement block for use in the wave generation system of FIG. 1;

FIG. 5D is an schematic, perspective view of another illustrative embodiment of a displacement block for use in the wave generation system of FIG. 1;

FIG. 6 is a schematic diagram of an illustrative embodiment of an input source comprising a pneumatic actuator for powering the wave generation system of FIG. 1;

FIGS. 7A to 7C are a schematic, side view of illustrative embodiments of dynamically balancing the wave generation system 102 of FIG. 1;

FIG. 8 is schematic, perspective view of an illustrative embodiment of three wave generation systems of FIG. 3 arranged side-by-side for use in the energy transfer system of FIG. 1;

FIG. 9 is a schematic, perspective view of an illustrative embodiment of a wave capture system for use in the energy transfer system of FIG. 1;

FIG. 9A is a schematic, side view of an illustrative embodiment of a piston assembly for use in the wave capture system of FIG. 9;

FIG. 9B is a schematic, side view of the wave capture system of FIG. 9 utilizing the piston assembly of FIG. 9A;

FIG. 9C is a schematic, perspective view of an illustrative embodiment of the wave capture system of FIG. 9 utilizing multiple piston assemblies.

FIG. 10 is a schematic, perspective view of an illustrative embodiment of a buoyancy block device for use in a wave capture system such as the wave capture system of FIG. 1.

FIG. 10A is a schematic, perspective view of an illustrative embodiment of three buoyancy block devices for use in a wave capture system such as the wave capture system of FIG. 1;

FIG. 10B is a schematic, perspective view of another illustrative embodiment of a buoyancy block device for use in a wave capture system such as the wave capture system of FIG. 1;

FIG. 11 is a schematic, perspective view of another illustrative embodiment of an energy transfer system;

FIG. 12A is a schematic, top view of an illustrative embodiment of an energy transfer system employing a circular tank;

FIG. 12B is a schematic, top view of an illustrative embodiment of an energy transfer system employing a cross-shaped tank;

FIG. 13A is a schematic, top view of an illustrative embodiment of an energy transfer system employing a Y-shaped tank;

FIG. 13B is a schematic, top view of another illustrative embodiment of an energy transfer system employing a Y-shaped tank;

FIG. 14 is a schematic, perspective view of another illustrative embodiment of an energy transfer system employing a Y-shaped tank;

FIG. 15 is a schematic, perspective view of an illustrative embodiment of an energy transfer system utilizing an offshore platform;

FIG. 16 is a schematic, perspective view of an illustrative embodiment of an artificial pump head;

FIG. 17 is a schematic, cross-sectional view of the artificial pump head of FIG. 16;

FIG. 18 is a schematic, perspective view of another illustrative embodiment of an artificial pump head;

FIG. 19 is a schematic, cross-sectional view of an illustrative embodiment of an artificial pump head system;

FIG. 20 is a schematic, perspective view of another illustrative embodiment of an artificial pump head system; and

FIG. 21 is a schematic, cross-sectional view of another illustrative embodiment of an artificial pump head system.

### DETAILED DESCRIPTION

In the following detailed description of several illustrative embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments are defined only by the appended claims.

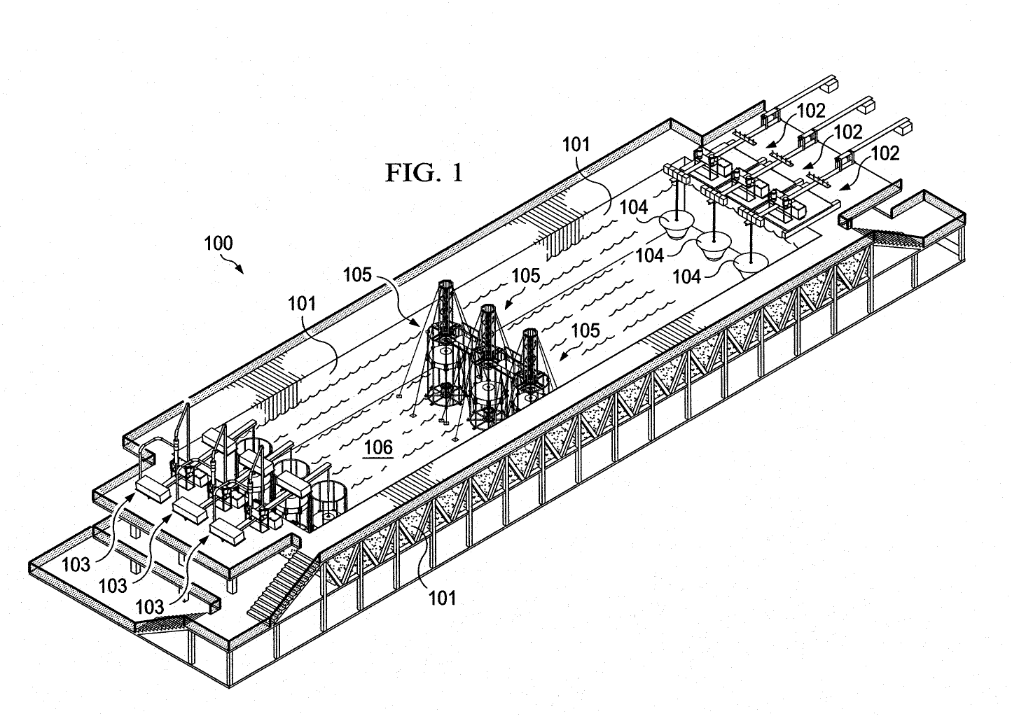

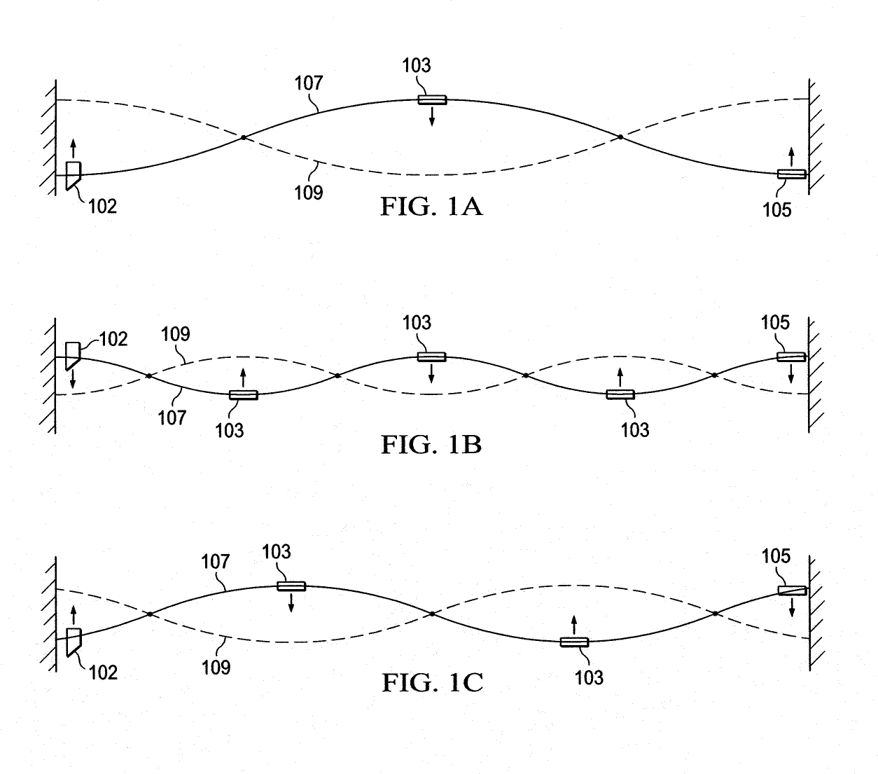

Referring to FIG. 1, an energy transfer system 100 may be disposed in a land-based tank 101. The tank 101 may be constructed from a wide variety of materials including, but not limited to, shipping and/or storage containers that have been stacked and welded together, concrete, wood, plastic, sheet metal, stone, and dirt. If the tank 101 is constructed in a fashion where it is sealed sufficiently to contain fluid, the tank 101 may also include a plastic liner or other sealing device to minimize or prevent leakage of liquid from the tank 101. The energy transfer system 100 includes a plurality of wave generation systems 102 positioned at a first end of the tank 101 and a plurality of wave capture systems 103 positioned at a second end of the tank 101. A plurality of buoyancy pump devices 105 may be positioned approximately in the center of the tank 101 between the wave generation systems 102 and the wave capture systems 103 or in other locations as will be described more detail below. An example of such buoyancy pump devices 105 are described in applicant's commonly-owned U.S. Pat. Nos. 6,953,328; 7,059,123, 7,258,532; 7,257,946; 7,331,174; 7,584,609; 7,735,317; 7,737,572; and U.S. patent application Ser. Nos. 12/775,357 and 12/775,375, all of which are hereby incorporated by reference, and can be purchased from Texas National Resources, Inc. located in Houston, Tex. Each of the wave generation systems 102 includes a displacement block 104 for generating waves in a liquid such as water 106 contained within the tank 101. The buoyancy pump devices 105 and wave capture systems 103 are interchangeable with respect to the operation of energy transfer systems 100.

The wave generation systems 102 may be operated to generate a variety of different wave sizes, wave patterns, and wave profiles when the displacement block 104 is oscillated between an engaged and disengaged position in the water 106. Wave characteristics include a crest at the top and a trough at the bottom of the wave. The difference in elevation between the crests and the trough is the wave height. The distance between the crests or the troughs of the waves is termed the wavelength. The wave period is the length of time it takes for a wave to pass a fixed point, e.g., crest to crest or trough to trough. The speed of the wave is equal to the wavelength divided by the wave period. The ratio of the wave height to the wave length is the steepness of the wave. When the wave builds and reaches a steepness greater than a ratio of 1:7 such as, for example, 1:6, 1:5, and 1:4, the wave breaks and spills forward because it becomes too steep to support itself against the force of gravity. A wave having a steepness of less than the ratio of 1:7 such as, for example, 1:8, 1:9, and 1:10, referred to as a usable wave. Usable waves in a tank may have two forms, (i) forced waves created by maximum force requiring a variable frequency input to maintain wave height, or (ii) natural waves generated by a diminishing force until a stable balance is met between natural wave movement and wave height according to a set frequency input.

The displacement block 104 creates a disturbing force in the water 106 to generate a natural or forced wave that propagates through the water 106 in a generally linear direction defined by the side walls of the tank 101. The water 106 is sufficiently deep to accommodate the height of the wave to be generated in the tank. After the wave travels the full length of the tank 101, that wave is then reflected off the opposing end wall of the tank 101 back to the displacement block 104. The displacement block 104 is oscillated at a frequency to generate a desired number of natural waves within the tank 101. Thus, the wave generation systems 102 may generate a series of natural waves forming a wave pattern containing two, three, four, or more waves depending on size of the wave and the length of the tank 101. Natural or forced waves can propagate for more than a mile with only minimal changes in the shape and the speed of the wave as it propagates through water. As natural or forced waves pass through one another and constructively and destructively interfere with one another, an interference pattern known as a standing wave pattern appears. As shown in FIG. 1A-1C, a standing wave pattern oscillates between two states in which the peaks of state one 107 become the troughs of state two 109, and the peaks of state two 109 become the troughs of state one 107.

FIGS. 1A-1C illustrate three standing wave patterns generated by the wave generation systems 102, i.e., a two-wave, three-wave, and four-wave pattern, each wave pattern comprising a series of crests and troughs collectively referred to as the peaks of the waves. In a first example shown in FIG. 1A, the wave pattern generated includes two standing waves as represented by a solid line 107 and having three peaks, i.e., a first peak (trough) at one end of the tank 101 that is underneath the displacement block 104 of the wave generation systems 102, a second peak (trough) at the other end of the tank 101 that is captured by the wave capture systems 103, and a third peak (crest) in the center of the tank 101 that is captured by the buoyancy pump devices 105. After one-half cycle, this standing wave pattern oscillates such that the three peaks include two crests and one trough as represented by a dashed line 109.

In a second example shown in FIG. 1B, the wave pattern generated includes four standing waves having five peaks, i.e., a first peak underneath the displacement block 104 of the wave generation systems 102, a second peak captured by the wave capture systems 103, and three other peaks captured by the buoyancy pump devices 105 with one peak in the center and two others between the center peak and peaks at the end of the tank 101. Thus, the wave capture systems 103 and the buoyancy pump devices 105 are positioned at locations in the tank 101 where peaks of the standing waves are formed in the tank 101 as the result of the wave generation systems 102 moving the displacement blocks 104 up and down in the water 106. In a third example shown in FIG. 1C, the wave pattern generated includes three standing waves having four peaks. Although the standing wave pattern shown in FIG. 1B includes four standing waves with five peaks, the tank 101 only includes one row of the buoyancy pump devices 105 even though two more rows could be included as shown in FIG. 1B and described above. Operation of the wave capture systems 103 and the buoyancy pump devices 105 providing the movement of water/fluid or air/gas that can be used for mechanical or electrical energy generation.

As indicated above, the wave generation systems 102 are capable of generating any number of standing waves in the tank 101. Comparing the standing wave patterns in FIGS. 1A and 1B, for example, any attempt to increase the number of waves and the corresponding number of peaks to generate more energy with two more rows of the buoyancy pump devices 105 is limited by the height of the wave as a result of the restriction on the steepness of the wave, i.e., smaller wave length, smaller wave height. However, if the length of the tank 101 is doubled, the same wave height shown in FIG. 1A can be generated in a wave pattern of four standing waves as shown in FIG. 1B. Thus, the wave generation systems 102 are capable of generating more standing waves of the same wavelength as the length of the tank 101 increases to generate a greater output.

As indicated above, operation of the wave capture systems 103 and the buoyancy pump devices 105 may be used for the generation of mechanical or electrical energy. In another embodiment, the conventional buoyancy pump devices 105 located in the center of the tank 101 may also be used to circulate water within the tank 101. Additionally, the tank 101 and wave generation systems 102 are useful as a wave testing apparatus to test wave energy devices and other structures that may be exposed to certain wave conditions. The ability of the wave generation systems 102 at one end of the tank 101 to generate waves that are then captured by the wave capture systems 103 at another end of the tank and the buoyancy pump devices 105 at the center of the tank 101 also provides a unique method and system for transferring energy from one location to another, hence the energy transfer system 100 which is described in more detail as follows.

Additionally, the ability of the energy transfer system 100 to convert one source of input energy, into another form of energy using artificially generated waves and buoyancy blocks is disclosed. As a specific, non-limiting example, it is possible to use an electric motor or other input system to provide the input energy to the wave generation systems 102, and use the buoyancy pump devices to deliver high-pressure water to a reverse-osmosis membrane, thus desalinating water. In a different specific, non-limiting example, it is possible to use a waterwheel in a stream or other forms of input devices to provide the input energy to drive the wave generation systems 102, and use the buoyancy pump devices to move water through a hydroelectric turbine, thus generating hydroelectric power for a remote location without an expensive dam.

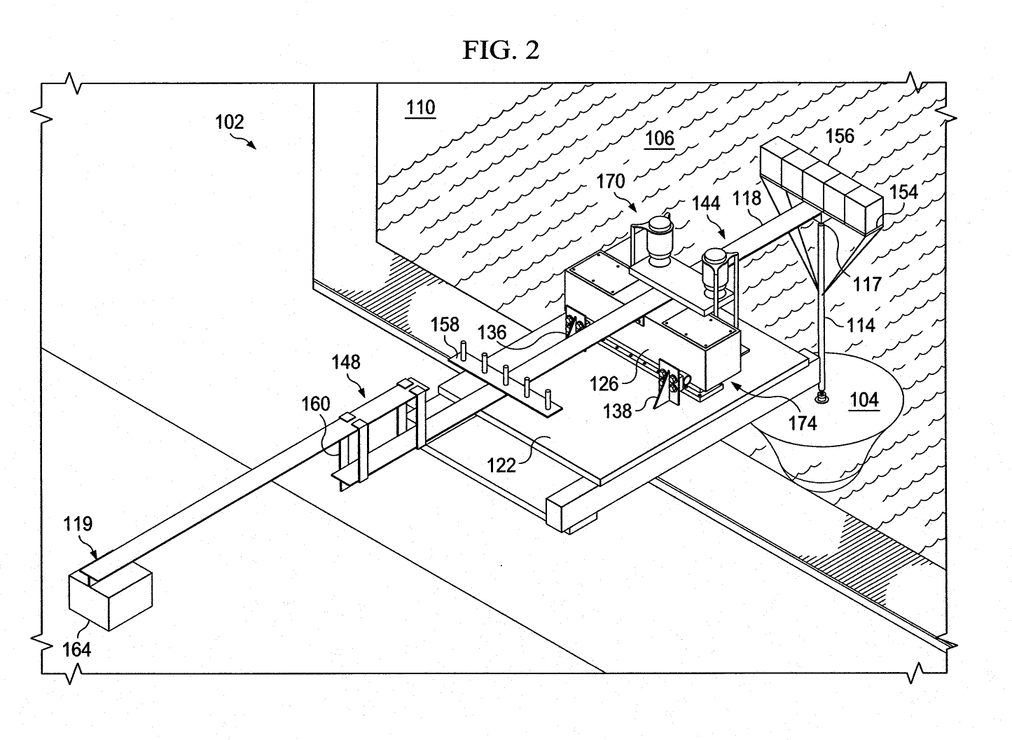

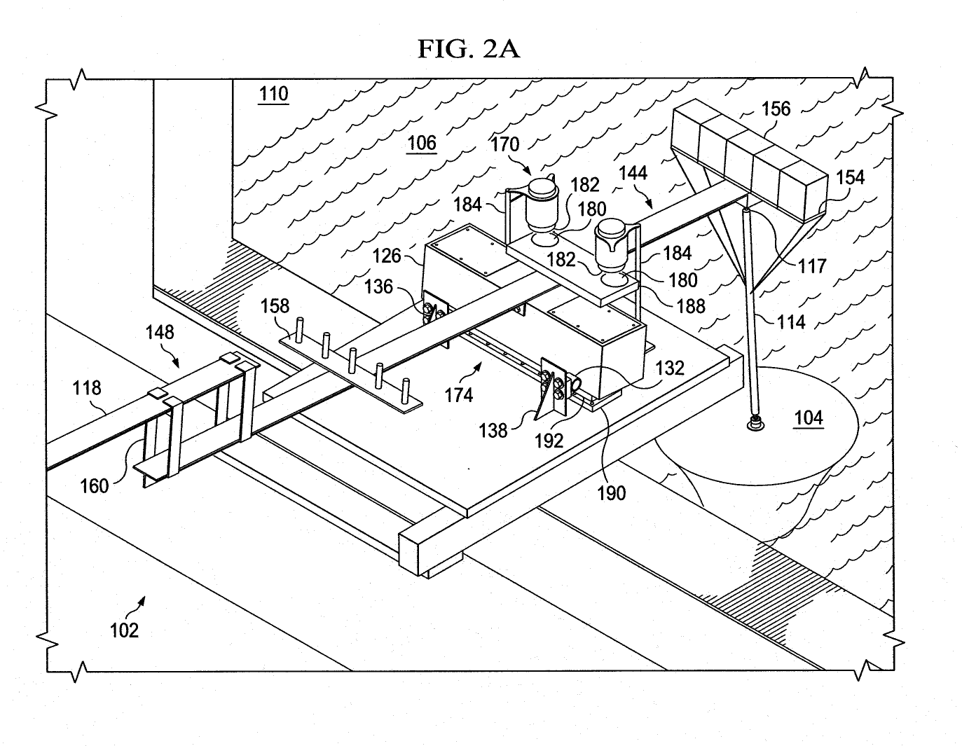

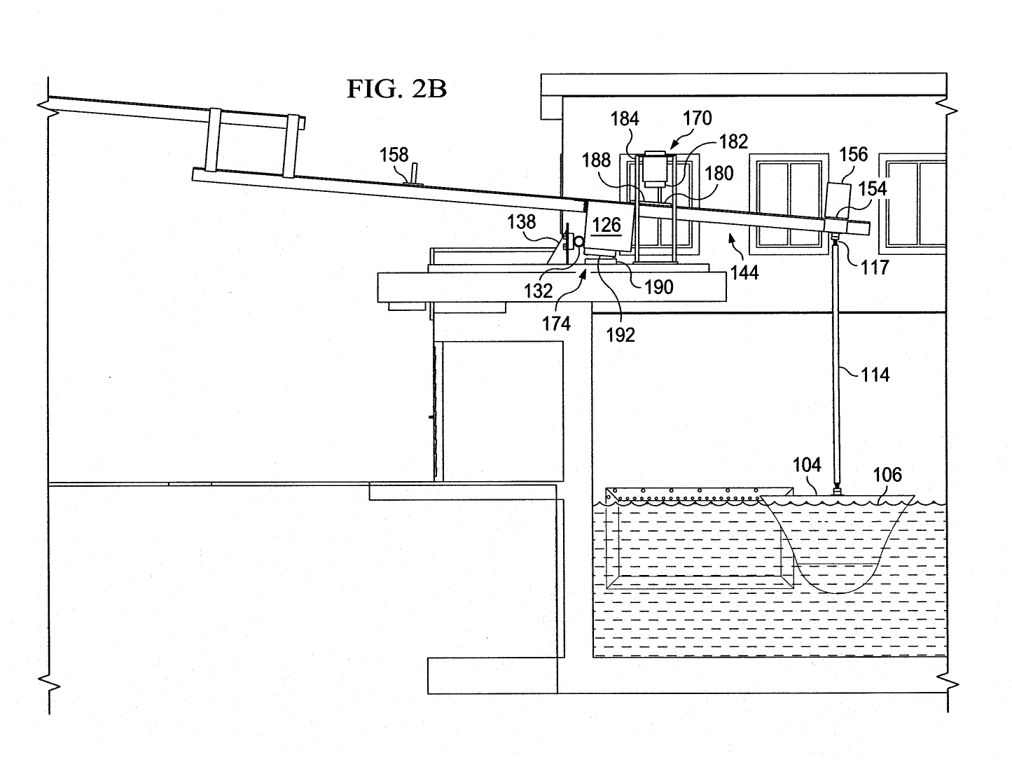

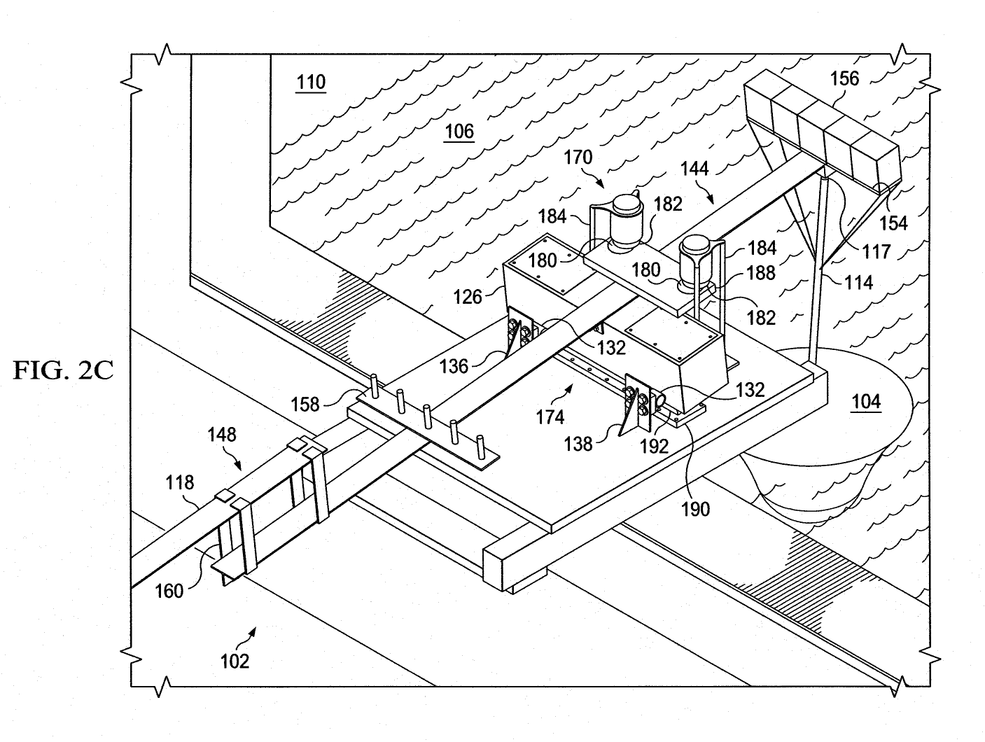

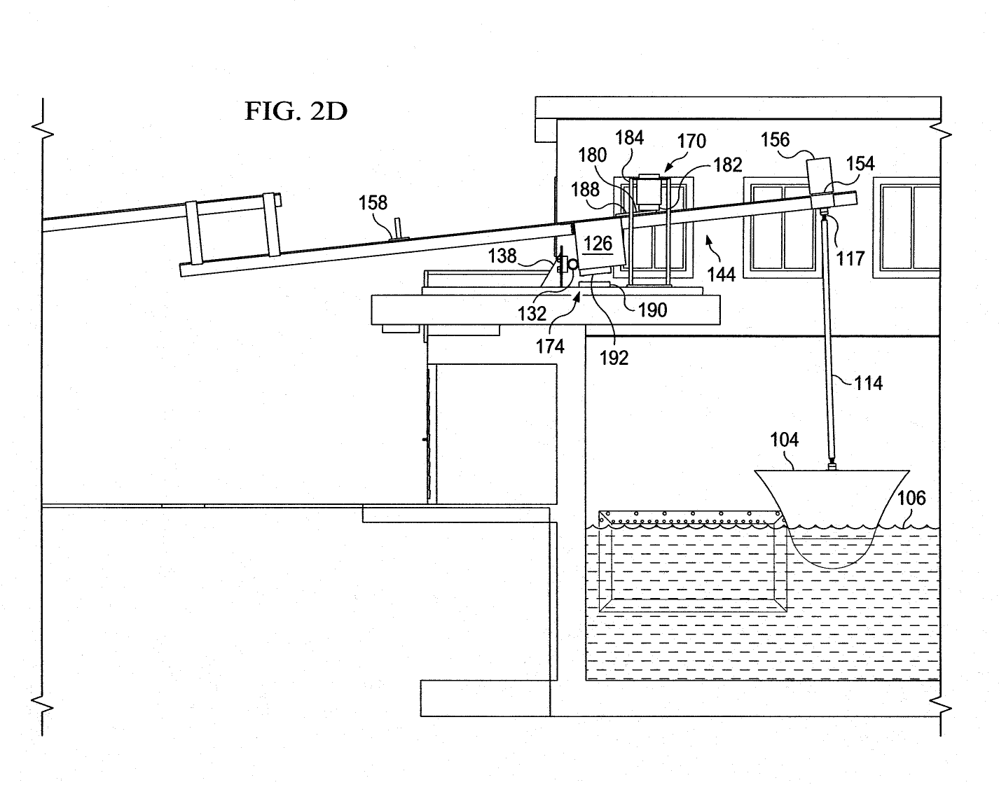

Referring now to FIGS. 2, 2A and 2B, the wave generation systems 102 includes the displacement block 104 for generating waves in the water 106 contained in the tank 101 or other container. Although the displacement block 104 is shown as having the shape of a plunger similar to an upside down bell, the displacement block 104 may have a variety of different shapes to generate different wave patterns as will be described in more detail below. In this embodiment, the displacement block 104 is connected by a plunger rod 114 to a first end 117 of a transfer arm 118. The transfer arm 118 is pivotally attached to a base 122. In the embodiment illustrated in FIG. 2, the base 122 is stationary relative to the tank 101 and does not move in conjunction with waves in the water 106. The pivotal connection of the transfer arm 118 to the base 122 is illustrated in more detail in FIGS. 2A and 2B. The transfer arm 118 is rigidly connected to a support block 126, and the support block 126 is pivotally connected by the hinges 130, 132 to supports 136, 138. The supports 136, 138 are rigidly connected to the base 122.

The pivotal connection provided by the hinges 130, 132 allows the transfer arm 118 to rotate relative to the base 122 about an axis of rotation passing through both the hinges 130, 132. While the hinges 130, 132 are typical pin-and-sleeve hinges, alternative devices may be used to provide rotation between the transfer arm 118 and the base 122. In one embodiment, a “living hinge” made from a flexible material may be connected between the support block 126 and the base 122. In another embodiment, a pillow block or other bearing may be use to provide pivotal rotation. While this embodiment of the wave generation system 102 includes a pair of hinges, other suitable designs may rely on only a single, piano-style hinge or may include multiple hinges in excess of two hinges.

The transfer arm 118 is preferably an elongated beam member or arm that includes a first portion 144 extending from the first end 117 of the transfer arm 118 to one side of the axis of rotation and a second portion 148 on an opposite side of the axis of rotation. In one embodiment, the displacement block 104 is connected to the first portion 144 of the transfer arm 118 at or near the first end 117 of the transfer arm 118. While the displacement block 104 may be located at the first end 117 of the transfer arm 118, the displacement block may be positioned and connected along the transfer arm 118 at another location in the first portion 144 closer to the hinges 130, 132 depending on several factors as described below in more detail. Referring back to FIG. 2, the transfer arm 118 may be a two-piece arm joined by splice members 160. Splicing two or more beams or arms together may be performed to acquire the desired length of the transfer arm 118. For purposes of the present application, the transfer arm 118 will be referred to as if it were a single-piece arm or beam extending to a second end 119, but it should be understood that the transfer arm 118 may be comprised of multiple arms or other components as necessary to achieve the desired leverage.

An input source 164 is operably associated with the second end 119 of the transfer arm 118. The input source 164 may be any type of power source or apparatus that is capable of imparting a force to, and thus moving, the transfer arm 118. In one embodiment, the input source 164 may be a gas engine or electric-driven motor that is capable of reciprocally moving the transfer arm 118. If an engine or motor is used as the input source 164, an output shaft of the input source 164 may be operably associated with a direct-drive mechanism such as a drive shaft or gear, or a belt-driven mechanism, or a cam-type linkage to connect the output of the motor to the transfer arm 118. In another embodiment, the input source 164 may be a linear-elastic actuator that imparts force to the transfer arm 118 by means of a spring having sufficient strength to deliver the desired force to the transfer arm 118. In yet another embodiment, the input source 164 may be a pneumatic actuator that utilizes a source of compressed air to drive a dual-chamber pneumatic cylinder that provides a pulling and pushing action to the transfer arm 118.

The transfer arm 118 may be pivoted operationally between a lower engaged position and an upper disengaged position. The input source 164 raises the second end 119 of the transfer arm 118 to lower the first end 117 of the transfer arm 118 into the engaged position such that a substantial portion of the displacement block 104 is submerged in the water 106 thereby increasing displacement of the block 104. The input source 164 then lowers the second end 119 of the transfer arm 118 to raise the first end 117 of the transfer arm 118 into the disengaged position such that a substantial portion of the displacement block 104 is lifted from the water 106 thereby decreasing displacement of the block 104. This oscillating variation in displacement generates movement of the water 106 that creates a wave pattern in the tank 101. Thus, the operational range of movement between the engaged position and the disengaged position for the transfer arm 118 where connected to the plunger rod 114 is controlled to generate a desired wave height of the wave in the tank 101.

Referring still to FIG. 2, but more specifically to FIGS. 2A and 2B, the wave generation systems 102 includes a first spring member 170 operably associated with the transfer arm 118 and a second spring member 174 operably associated with the transfer arm 118. In the embodiment of the wave generation systems 102 as illustrated, the first and second spring members 170, 174 are each a pair of opposing magnets that exert substantial repelling forces on the transfer arm 118 which bias the transfer arm 118 and the displacement block 104 in either a downward or upward direction as the transfer arm 118 moves from the engaged position to the disengaged position and back.

The first spring member 170 includes a pair of lower magnets 180 and a pair of upper magnets 182. Each of the upper magnets 182 is mounted to a support member 184 that is affixed relative to the base 122. Each of the lower magnets 180 is positioned on a plate 188 that is mounted to an upper surface of the transfer arm 118. In one embodiment, each one of the pair of lower magnets 180 is located an equal distance from the transfer arm 118, and each one of the lower magnets 180 is aligned below one of the upper magnets 182. The orientation of each lower magnet relative to the corresponding upper magnet 182 is such that like poles of the magnets face one another. This orientation of the magnets results in a repulsive biasing force between the lower magnets 180 and the upper magnets 182. The biasing force is directed downwardly on the plate 188 and, therefore, increasing against the transfer arm 118 as the transfer arm 118 moves upward, i.e., a downward biasing force. The downward biasing force varies depending on the distance between the corresponding lower and upper magnets 180, 182, which is dependent on the position of the transfer arm 118. When the transfer arm 118 is in the engaged position (see FIG. 2A), the distance between the corresponding lower and upper magnets 180, 182 is greatest such that the downward biasing force between the magnets is at a minimum value. As the transfer arm 118 moves toward the disengaged position, the distance between the corresponding lower and upper magnets 180, 182 decreases to the smallest value such that the downward biasing force increases to a maximum value.

The second spring member 174 includes a plurality of lower magnets 190 and a plurality of upper magnets 192. Each of the upper magnets 192 is mounted to the support block 126 or to a plate (not shown) that is connected to the support block 126. Each of the lower magnets 190 is connected to the base 122 or to a plate (not shown) that is connected to the base 122. The orientation of each of the lower magnets 190 relative to the corresponding upper magnets 192 is such that like poles of the magnets face one another. This orientation of the magnets results in a repulsive biasing force between the lower magnets 190 and the upper magnets 192. The biasing force is directed upwardly on the support block 126, and, therefore, increasing against the transfer arm 118 as the transfer arm 118 moves downward, i.e., an upward biasing force. The upward biasing force varies depending on the distance between the corresponding lower and upper magnets 190, 192, which is dependent on the position of the transfer arm 118. When the transfer arm 118 is in the disengaged position (see FIG. 2B), the distance between the corresponding lower and upper magnets 190, 192 is greatest such that the upward biasing force between the magnets is at a minimum value. As the transfer arm 118 moves toward the engaged position, the distance between the corresponding lower and upper magnets 190, 192 decreases to the smallest value such that the upward biasing force increases to a maximum value.

The strength of each magnet and the number of magnets used with each spring member may vary depending on the biasing forces required to accommodate the length and weight of the transfer arm, the weight and positioning of the displacement block, and the positioning of the axis of rotation about which the transfer arm rotates. Based on these same parameters, the positioning of the first spring member 170 and second spring member 174 may vary along the transfer arm 118 from the axis of rotation. Each of the magnets 180, 182, 190, 192 may be, for example, a permanent neodymium magnet having a strength or flux density of approximately 14,500 gauss with a pull force of approximately 250 pounds. Each of the magnets 180, 182, 190, 192 may comprise a plurality of such neodymium magnets positioned side by side to increase the flux density in order to provide the necessary repulsive force to bias the components of larger configurations of the wave generation systems 102. For example, a pair of neodymium magnets may be utilized to provide a total magnetic strength of 29,000 gauss with a pulling force of approximately 500 pounds to accommodate a larger configuration of the transfer arm 118 that supports a larger configuration of the displacement block 104. Any number of neodymium magnets may be positioned side by side to form a magnetic bar to provide the necessary magnetic strength required for operation of the larger configuration of the wave generation systems 102.

As an alternative to the magnetic systems described herein, other types of spring or dampening components may be used Possible alternatives include, without limitation, mechanical springs, electro-magnetic springs, visco-elastic springs, or any other type of spring system.

Referring still to FIG. 2, the wave generation systems 102 further includes a first counterweight plate 154 on the first portion 144 of the transfer arm 118. Similarly, a second counterweight plate 158 is positioned on the second portion 148 of the transfer arm 118. Additional counterweights 156 may be positioned on the first counterweight plate 154, but initially no additional weight is positioned on the second counterweight plate 158. The amount of additional counterweight positioned on each side of the axis of rotation of the transfer arm 118 may vary based on several design parameters, including the distance the counterweight is positioned from the axis of rotation, to achieve the desired balance. One goal of using counterweights on opposite sides of the axis of rotation is to balance the transfer arm 118 to a substantially neutral position in which the transfer arm 118 is substantially level. Another benefit of the use of counterweights will be described in more detail below, but generally relates to improving the effective mechanical advantage provided by the transfer arm 118 to reduce the amount of force required by the input source 164 to move the displacement block 104 up and down in the water 106. It should be noted that the amount of counterweight provided may be varied, and the positioning of the counterweight plates (and thus the counterweights) may be varied to achieve this mechanical advantage. In one embodiment, counterweights may be connected directly to the transfer arm 118 without the use of counterweight plates.

In operation, the wave generation systems 102 is capable of converting energy input to the transfer arm 118 by the input source 164 into wave energy in the tank 101. The input source 164 is capable of moving the transfer arm 118 between the engaged position and the disengaged position. As a second end 119 of the transfer arm 118 is moved upward by the input source 164, a first end 117 travels downward and plunges the displacement block 104 into the water 106. The displacement of water in the tank 101 generates a wave in the tank 101 that is capable of traveling the length of the tank 101 and then returning when the wave strikes the end wall or bulkhead of the tank 101. After the transfer arm 118 is moved into the engaged position to at least partially submerge the displacement block 104, the transfer arm 118 is then moved toward and into the disengaged position. As the transfer arm 118 moves toward and into the disengaged position, the displacement block is mostly removed from the water 106. The continued cycle of moving the transfer arm 118 to the engaged position and then to the disengaged position, which results in the displacement block 104 being pushed into the water 106 and then mostly removed from the water 106, creates multiple waves in the water 106 that travel down the length of the tank 101 and back to the displacement block 104.

The motion of the displacement block 104 is timed to move back to the engagement position when the first wave returns so that a second wave is formed to constructively interfere with the first wave whereby the combined wave height is approximately doubled. Correspondingly, the motion of the displacement block 104 is timed to disengage and return back to the engagement position when the combined wave returns so that a third wave is formed to constructively interfere with the combined wave whereby the newly combined wave height is approximately triple the size of the first wave. This process is continued until the desired wave height is formed in the tank 101 as limited by the steepness restrictions described above and the ability of the displacement block 104 to create usable waves. The motion of the displacement block 104 may also be timed to move between the engagement and disengagement positions at a specific frequency to create multiple waves traveling down the length of the tank 101 and returning to the displacement block 104 in sequence. Thus, the displacement frequency of the displacement block 104 may be set to generate any number of standing waves in the tank 101 as illustrated, for example, in FIGS. 1A, 1B, and 1C which show a two-wave pattern, a three-wave pattern, and a four-wave pattern.

The first spring member 170 and second spring member 174 work together to facilitate the motion of the transfer arm 118 when the displacement block 104 changes directions between the engagement and disengagement positions. The first spring member 170 and the second spring member 174 each serve to provide a spring-like biasing force at both positions to the transfer arm 118, i.e., the downward and upward biasing force, respectively, described above. The presence of the first and second spring members 170, 174 during operation of the wave generation systems 102 aid in urging the transfer arm 118 from the engaged and disengaged positions back to a level or neutral position.

As the transfer arm 118 is moved into the engaged position, a buoyancy force associated with the displacement block 104 being at least partially submerged acts on the transfer arm 118 to urge the transfer arm 118 back toward the neutral position. In the engaged position, the lower and upper magnets 190, 192 of the second spring member 174 are as close to one another in distance as is possible given the pivotal path of the transfer arm 118. With such proximity, the repulsive force between the lower and upper magnets 190, 192 is greatest. The repulsive force is directed to the transfer arm 118 to upwardly bias the transfer arm 118 back toward the neutral position. In the engaged position, the lower and upper magnets 180, 182 of the first spring member 170 are as separated from one another in distance as is possible given the pivotal path of the transfer arm 118. In this position, the repulsive force between the lower and upper magnets 180, 182 is less than in any other position of the transfer arm 118.

When the transfer arm 118 has moved to the disengaged position, the lower and upper magnets 180, 182 of the first spring member 170 are as close to one another in distance as is possible given the pivotal path of the transfer arm 118. With such proximity, the repulsive force between the lower and upper magnets 180, 182 is greatest. The repulsive force is directed to the transfer arm 118 to downwardly bias the transfer arm 118 back toward the neutral position. In the disengaged position, the lower and upper magnets 190, 192 of the second spring member 174 are as separated from one another in the farthest distance possible given the pivotal path of the transfer arm 118. In this position, the repulsive force between the lower and upper magnets 190, 192 is less than in any other position of the transfer arm 118.

The use of the transfer arm 118 and the corresponding counterweight 156 provides mechanical advantage, which allows the input source 164 to provide a smaller input force than would normally be required to submerge the displacement block 104. The improved mechanical advantage provided by the transfer arm 118 and counterweights reduce the amount of force required by the input source 164 to move the displacement block 104 up and down in the water 106. Depending on the size of the displacement block 104, the amount of force required to submerge the displacement block 104 may be relatively high. With the axis of rotation of the transfer arm 118 positioned closer to the first end 117 than the second end 119 of the transfer arm 118, the transfer arm 118 is capable of acting as a lever, with the hinges 130, 132 being the fulcrum of the lever.

Substantial testing of a first prototype of the wave generation systems 102 as shown in FIGS. 2, 2A and 2B and having the characteristics set forth in Table I has been performed by the applicant to demonstrate the generation of waves in a smaller tank 101′ than shown in FIG. 2 wherein the transfer arm 118 and displacement block 104 were moved at different speeds and frequencies to generate different wave patterns. Table I sets forth the magnet characteristics of the first and second spring members 170, 174, each of which includes opposing pairs of disc-shaped magnets arranged side-by-side.

TABLE I
Wave Generator Characteristics

| Characteristics Features | First Wave | | Second Wave | |
|---|---|---|---|---|
| Of Wave Generators | Generator 102 | | Generator 302 | |
| First spring member 170, 370 | | | | |
| Size/No. of magnets (pairs) | 1 × 2 in./4(2) | | 2 × 6 in./16(8) | |
| Magnetic strength | 29,600 | G | 236,000 | G |
| Downward biasing force | 500 | lbs. | 18,720 | lbs. |
| Second spring member 174, 374 | | | | |
| Size/No. of magnets (pairs) | 1 × 2 in./20(10) | | 2 × 6 in./20(10) | |
| Magnetic strength - total | 148,000 | G | 296,000 | G |
| Upward biasing force | 2,500 | lbs. | 23,400 | lbs. |
| Transfer arm 118, 318 | | | | |
| Total Length | 108 | in. | 289 | in. |
| Length of first portion | 40.5 | in. | 74 | in. |
| Counterweight position from axis | | | | |
| First Counterweight 154, 354 | 36 | in. | 62 | in. |
| Second Counterweight 158, 358 | 12 | in. | 37 | in. |
| Displacement Block 104, 304 | | | | |
| Block Diameter | 15.25 | in. | N/A | |
| Block Front | N/A | | 132 | in. |
| Block Stroke | 5.5 | in. | 29 | in. |
| Block Buoyancy | 37.2 | lbs. | 11,000 | lbs. |
| Tank 101′, 101 | | | | |
| Length | 20 | ft. | 150 | ft. |
| Width | 4 | ft. | 40 | ft. |
| Water Depth | 18 | in. | 8 | ft. |

Table I also sets forth the dimensions of the transfer arm 118, the location of the counterweight plates 154, 158, the size of the displacement block 104, and the buoyancy force created by the displacement block 104. Table I also sets forth the dimensions of the smaller tank 101′ and the depth of the water 106. By varying the speed and frequency of movement of the transfer arm 118, the size and pattern of the waves created in the smaller tank 101′ were varied. In some testing scenarios, it was possible to create standing waves in various positions within the smaller tank 101′ as described above.

Improvement of the effective mechanical advantage provided by the transfer arm 118 and the counterweights 156 to reduce the amount of force required by the input source 164 for moving the displacement block 104 up and down in the water 106 resulted from experimentation related to the balancing of the first and second portions 144, 148 of the transfer arm 118. The amount of the additional counterweights 156 was varied to determine the amount of mechanical advantage that could be obtained by balancing these counterweights. For the embodiment shown in FIG. 2, the weight on the second counterweight plates 158 was negligible compared to the total weight on the first counterweight plate 154. The effective mechanical advantage was determined by computing the amount by which the input force of the input source 164 had been reduced when the additional counterweights 156 were positioned on the first counterweight plate 154, as shown by the weight reduction percentage shown in Table II.

TABLE II
Examples of Increasing Counterweight

| Operational Characteristics | | | | |
|---|---|---|---|---|
| Of Wave Generators 102 | Case 2 | Case 1 | Case 3 | Case 4 |
| First counterweight (lb) | 75 | 270 | 330 | 448 |
| Transfer Arm input (lb) | 16.18 | 11.18 | 9 | 6.31 |
| Weight lifted by Arm (lb) | 26.97 | 18.64 | 15 | 10.52 |
| Weight/Lift Ratio | 2.29 | 3.32 | 4.13 | 5.89 |
| Reduction in Buoyancy (lb) | 10.22 | 18.56 | 22.20 | 26.69 |
| Percent Weight Reduction (%) | 27.5% | 49.9% | 59.7% | 71.7% |

The test data set forth in Table II includes the amount of weight placed on the first counterweight plate 154 intended to increase the effective mechanical advantage associated with the transfer arm 118. As the additional counterweights 156 is increased, however, counterweight must also be added to the second counterweight plates 158 or to other locations along the second portion 148 of the transfer arm 118 to balance the transfer arm 118 in the neutral position when no input force is applied. After the transfer arm 118 is balanced, the table illustrates that the amount of input force required for moving the transfer arm 118 into the engaged position decreases as the amount of weight positioned on the first counterweight plate 154 increases. Correspondingly, the effective amount of weight lifted by the transfer arm 118 is reduced as weight is added yielding an increased weight to lift ratio, i.e., the effective mechanical advantage. As can be seen in Table II, the effective mechanical advantage increases from 2.29 to 4.13 when the first counterweight is increased from 75 lbs. (Case 2) to 330 lbs. (Case 3). Therefore, in the example given above for Case 3, the amount of force required to submerge the displacement block 104 is reduced by nearly 60% from 16 pounds to 9 pounds of force when the amount of weight positioned on the first counterweight plate 154 is increased from 75 lbs. to approximately 330 lbs.

The effective mechanical advantage associated with the transfer arm 118 applied to the oscillation of the displacement block is synonymous with lifting a load and pushing down on a load. This increase in the effective mechanical advantage could also be applied in other heavy moving applications beyond lifting and sinking a displacement block. An example of this is characterized as a heavy moving device (not shown) that is structurally similar to the wave generation system 102 with the replacement of the displacement block 104 with an alternative load (not shown). The heavy lifting device includes a transfer arm pivotally attached to a base to allow pivotal movement of the transfer arm between an engaged and a disengaged position. The transfer arm has a first end and a second end. The heavy lifting device further includes a load coupled to the first end of the transfer arm, a first spring member operably associated with the transfer arm to exert a first force on the transfer arm; and a second spring member operably associated with the transfer arm to exert a second force on the transfer arm. The first force is substantially opposite in direction to the second force. Counterweights may be present on both the first end and the second end. An input source is also operably associated with the transfer arm to move the transfer arm between the engaged position and the disengaged position for heavy lifting.

TABLE III
Increasing Counterweights

| Wave Generator 102 | | Larger Wave Generator | |
|---|---|---|---|
| | Reduction | | Reduction |
| Additional | of Input | Additional | of Input |
| Counterweight | Force 164 (%) | Counterweight | Force 164 (%) |
| 8.4 | 1.6% | 605 | 0.9% |
| 16.8 | 3.1% | 1210 | 1.8% |
| 33.7 | 6.3% | 2420 | 3.5% |
| 67.5 | 12.5% | 4841 | 7.0% |
| 75.0 | 26.9% | 9682 | 14.1% |
| 135 | 25.0% | 19364 | 28.2% |
| 270 | 50.0% | 38729 | 56.3% |
| 448 | 71.5% | 77458 | 78.2% |
| 540 | 75.0% | 154917 | 89.1% |
| 1080 | 87.5% | 309833 | 94.5% |
| 2160 | 93.8% | 619667 | 97.3% |
| 4320 | 96.9% | 1239330 | 98.6% |
| 8640 | 98.4% | | |

Referring now to Table III, a more detailed list of increasing counterweight on the first counterweight plate 154 for the wave generation systems 102 is shown in the first column with the estimated corresponding reduction in the input force as a percentage shown in the second column. For example, a counterweight of 270 pounds reduces the amount of input force required by 50% as illustrated by Case 1 in Table II. Increasing the counterweight to 540 pounds reduces the amount of input force by 75% indicating that there are diminishing marginal returns for adding additional counterweight over the displacement block 104. Similar data was calculated for a larger wave generation as indicated in the third and fourth columns of Table III. As can be seen, the diminishing marginal returns for adding additional counterweight over the displacement block is even more apparent as nearly 40,000 pounds of additional weight must be added to achieve an increased reduction of the input force from approximately 56% to 78%.

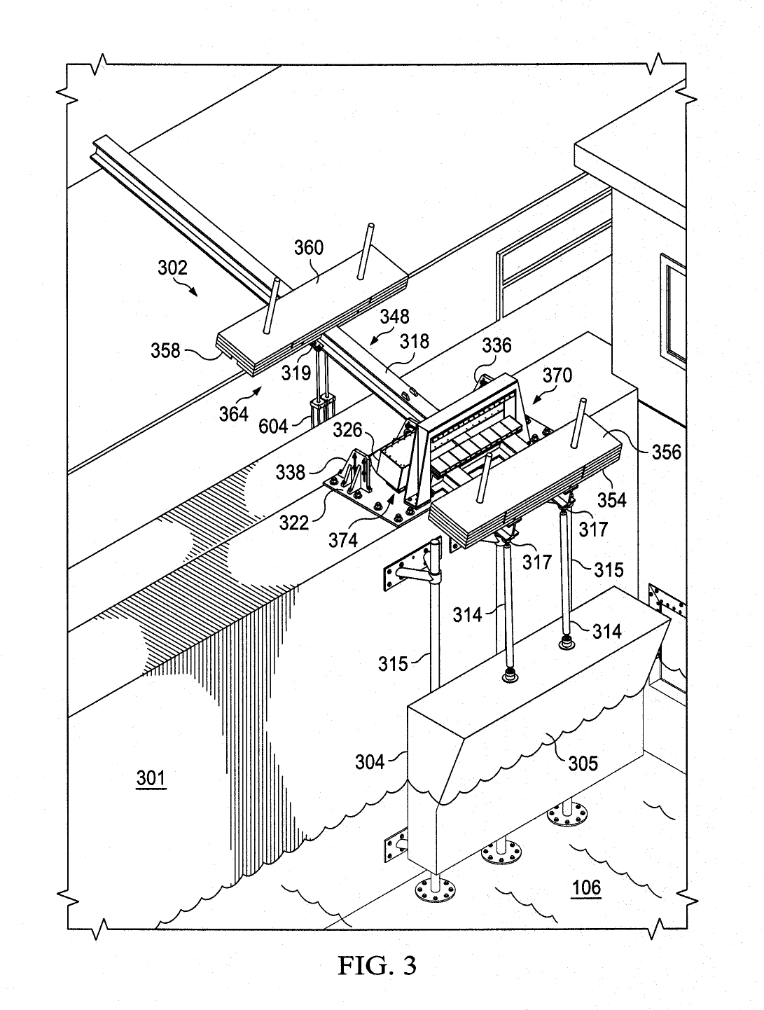

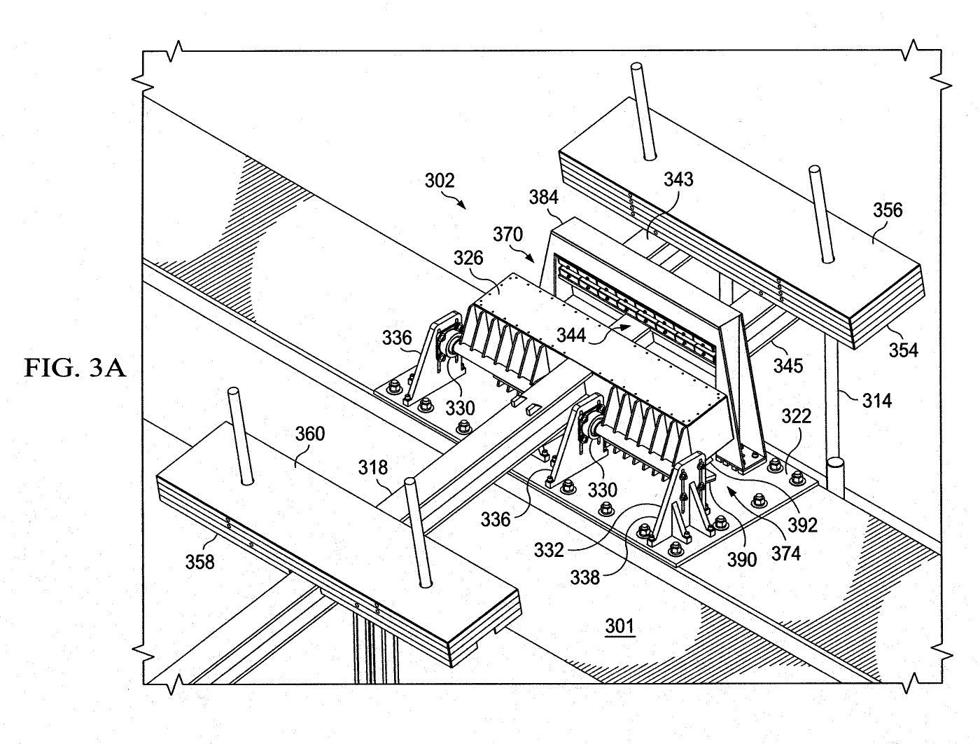

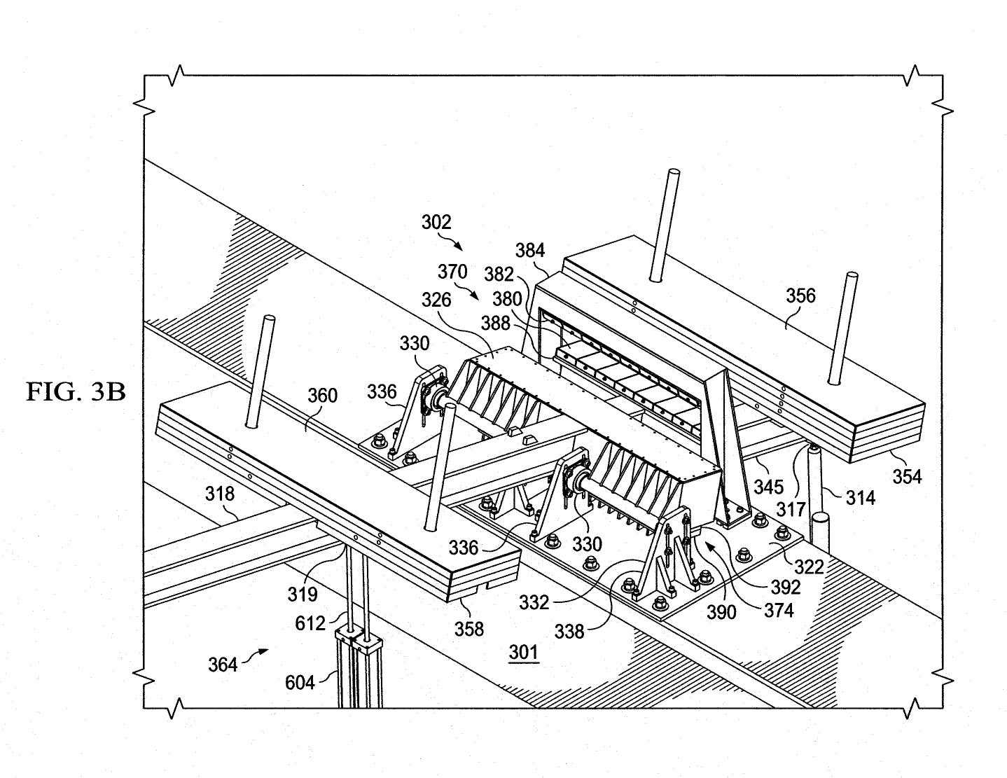

Referring now to FIGS. 3, 3A and 3B, a second wave generation system 302 is shown which has a substantially larger but similar structure compared to the first wave generation system 102 as indicated by the comparable numbering system. The physical characteristics of the wave generation system 302 are also set forth in Table I. The second wave generation system 302 also includes a displacement block 304 for generating waves in the water 106 contained in a larger tank 301 or other container having dimensions set forth in Table I. The displacement block 304 is connected by a plunger rods 314 to a first end 317 of a transfer arm 318 and slideably mounted on guide bars 315 rigidly connected to the tank 301. The transfer arm 318 is pivotally attached to a base 322. In the embodiment illustrated in FIG. 3, the base 322 is stationary relative to the tank 301 and does not move in conjunction with waves in the water 106. The pivotal connection of the transfer arm 318 to the base 322 is illustrated in more detail in FIGS. 3A and 3B. The transfer arm 318 is rigidly connected to a support block 326, and the support block 326 is pivotally connected by hinges 330, 332 to supports 336, 338. The supports 336, 338 are rigidly connected to the base 322.

Unlike the displacement block 104 having a plunger-shape, the displacement block 304 is rectangular in shape having a face 305 substantially perpendicular to the longitudinal axis of the tank 301 to generate a wave having a substantially straight or flat wavefront as compared to an arcuate wavefront generated by the displacement block 104 having a plunger shape. The shape and size of the displacement block may be varied depending on the size and shape of the tank 301 in which the wave generation system 302 is operating and the form of wave or wave pattern desired. Although the displacement block may be a simple rectangular-shaped block, the displacement block may have a variety of different shapes to generate the waveform and wave patterns needed in the tank 301.

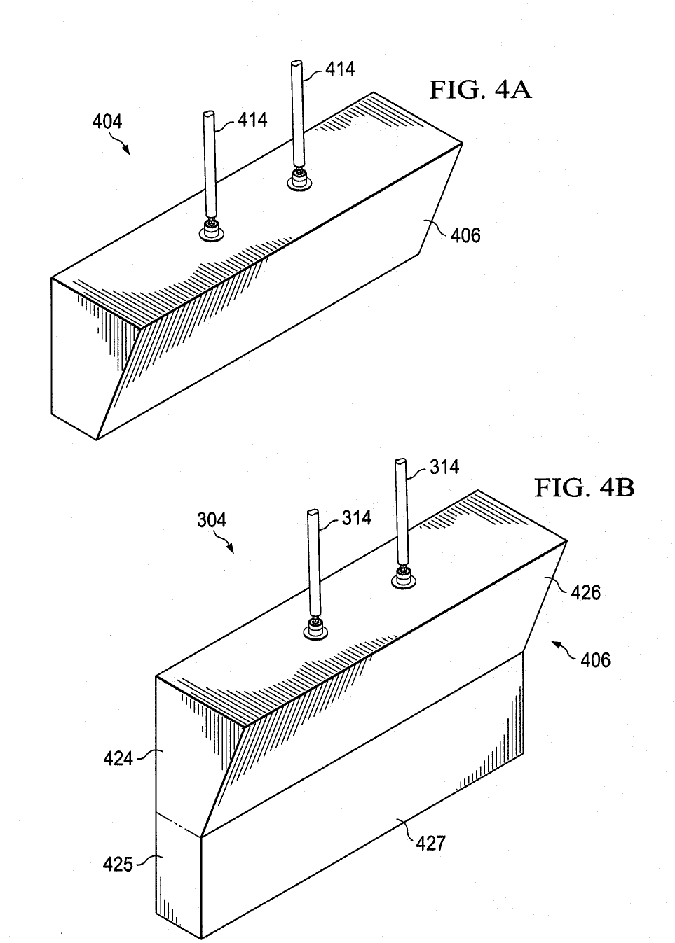

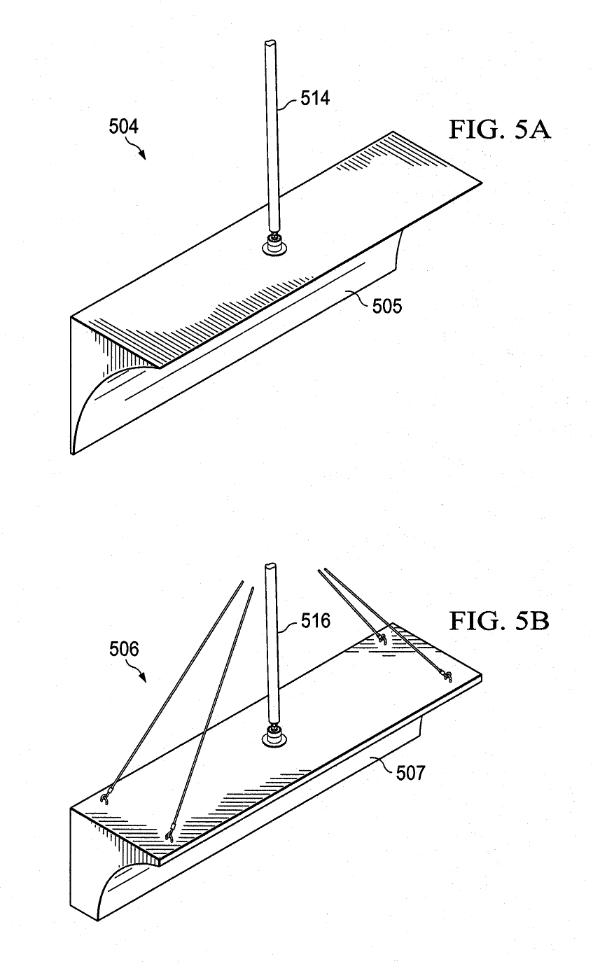

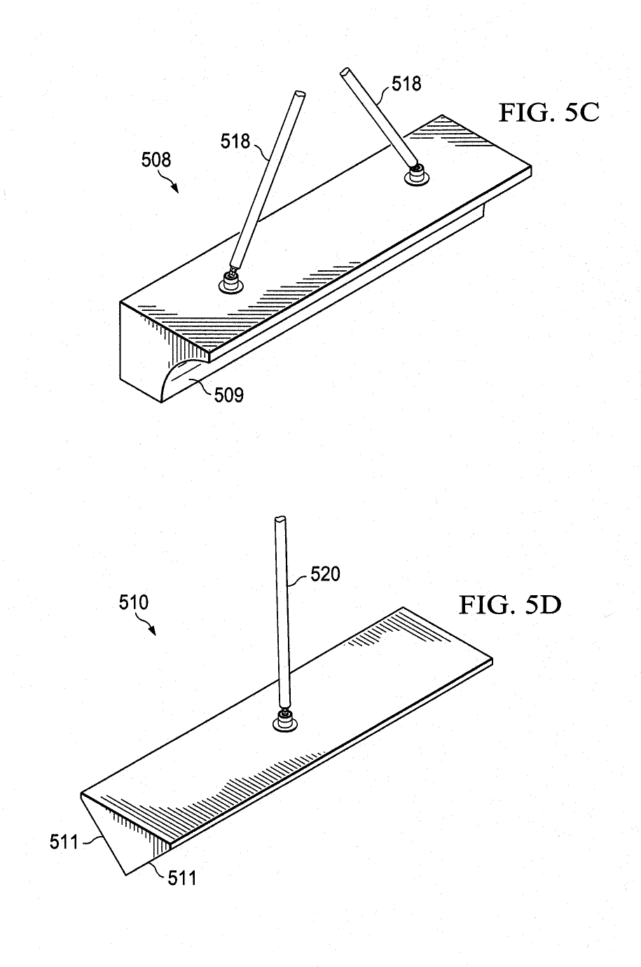

Referring more specifically to FIGS. 4 and 5, a variety of displacement blocks are illustrated. In FIG. 4A, a displacement block 404 having a single, inclined face 406 is provided. In one embodiment, dual plunger rods 414 may be provided to connect the displacement block 404 to the transfer arm. In FIG. 5A, a displacement block 504 having a concave face 505 is provided. In one embodiment, a single plunger rod 514 may be provided to connect the displacement block 504 to the transfer arm. In FIGS. 5B and 5C, displacement blocks 506, 508 are provided and include concave faces 507, 509 similar to the concave face 505 of the displacement block 504. While not limited to a particular configuration, two alternative configurations of plunger rods 516, 518 are provided to connect the displacement blocks 506, 508 to the transfer arm. Referring to FIG. 5D, a displacement block 510 having dual, inclined faces 511 is provided. In one embodiment, a plunger rod 520 may be provided to connect the displacement block 510 to the transfer arm. The presence of dual, inclined faces 511 may allow the displacement block 510 to operate particularly well when positioned in the center of a tank. The dual, inclined faces 511 may permit more efficient formation of waves traveling in opposite directions as will be illustrated below in more detail.

Referring to FIG. 4B, the displacement block 304 is shown as being a combination of an upper block portion 424 having an inclined face 426 and a lower block portion 425 having a substantially flat face 427 extending downwardly from the inclined face 426. The upper block portion 424 is substantially similar to the displacement block 404, while the lower block portion 425 is a rectangular-shaped block structure of approximately the same height. A variety of different connector devices may be used to transfer energy from the transfer arm 318 to the displacement block 304. This includes, but is not limited to, rigid rods, hydraulic or pneumatic pistons, cables, and magnetic systems.

Referring back to FIGS. 3A-3B, the pivotal connection provided by the hinges 330, 332 allows the transfer arm 318 to rotate relative to the base 322 about an axis of rotation passing through both the hinges 330, 332. While the hinges 330, 332 are typical pin-and-sleeve hinges, alternative devices may be used to provide rotation between the transfer arm 318 and the base 322. In this non-limiting embodiment, the transfer arm 318 is an elongated beam member or arm that includes a first portion 344 comprising two parallel beams 343, 345 extending from the first end 317 of the transfer arm 318 to one side of the axis of rotation and a second portion 348 on an opposite side of the axis of rotation. In one embodiment, the displacement block 304 is connected to the first portion 344 of the transfer arm 318 at or near the first end 317 of the transfer arm 318. While the displacement block 304 may be located at the first end 317 of the transfer arm 318, the displacement block 304 may be positioned and connected along the transfer arm 318 at another location in the first portion 344 closer to the hinges 330, 332 depending on several factors as described above in more detail. For purposes of the present application, the transfer arm 318 will be referred to as if it were a single-piece arm or beam extending from the first end 317 to a second end 319, but it should be understood that the transfer arm 318 may be comprised of multiple arms or other components as necessary to achieve the desired leverage.

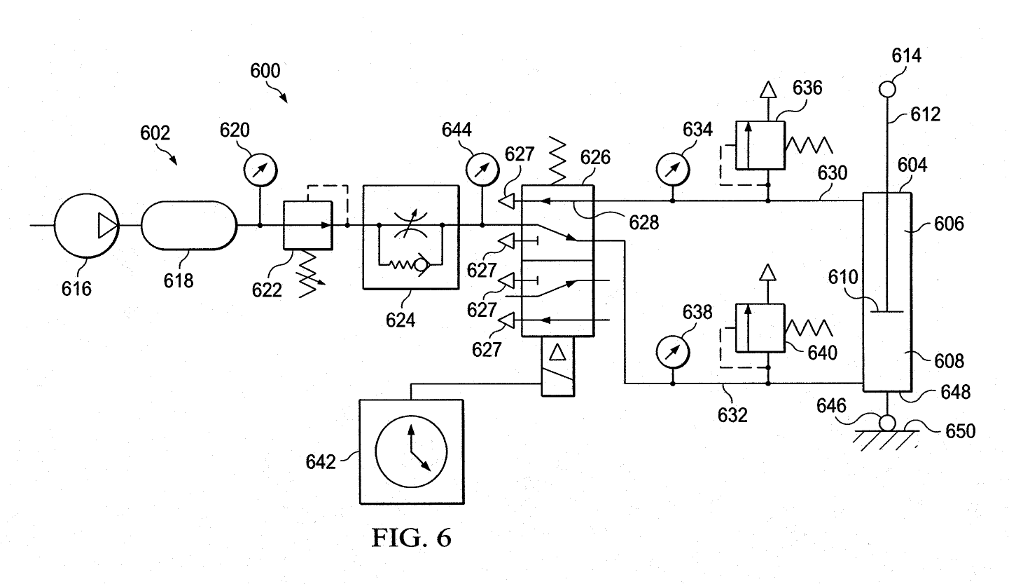

An input source 364 is operably associated with the second end 319 of the transfer arm 318. The input source 364 may be any type of power source or apparatus that is capable of imparting a force to, and thus moving, the transfer arm 318. In one embodiment, the input source 364 may be a pneumatic actuator that utilizes a source of compressed air to drive a dual-chamber pneumatic cylinder that provides a pulling and pushing action to the transfer arm 318. Referring more specifically to FIG. 6, a schematic drawing of a pneumatic actuator 600 that includes a source of compressed air 602 for driving a dual-chamber pneumatic cylinder 604 is shown. The pneumatic cylinder 604 comprises two chambers 606, 608 separated by a piston 610 connected to a piston rod 612. The piston rod 612 may be connected directly to the second end 319 of the transfer arm 318 by means of a ball joint 614 to facilitate a consistent power transfer, provided by the piston rod 612, along the arcuate path of the second end 319 of the transfer arm 318. Additionally, another ball joint 646 may be connected to a bottom portion 648 of the pneumatic cylinder 604, opposing the ball joint 614 connected to the piston rod 612. The ball joint 646 connects the bottom portion 648 of the pneumatic cylinder 604 to a stationary surface 650.

The source of compressed air 602 includes an air compressor 616 for compressing air and a compressed air pressure vessel 618 for holding the compressed air. The pressure levels of the compressed air contained in the compressed air pressure vessel 618 are monitored by at least one pressure gauge 620. The pneumatic actuator 600 further includes a pressure control valve 622 and a flow control valve 624 that are in fluid communication with the source of compressed air 602 and specifically, with the compressed air pressure vessel 618. The combination of the air compressor 616 and the compressed air pressure vessel 618 facilitate a stable and steady source of pressurized air to the pressure control valve 622. In one embodiment, the source of compressed air 602 does not include the compressed air pressure vessel 618. Whether the compressed air pressure vessel 618 is included as part of the source of compressed air 602 may depend on the type of air compressor used.

The pressure control valve 622 and the flow control valve 624 are in fluid communication with a directional control unit 626 having a direction control valve 628 that is operable to direct pressurized air received from the source of compressed air 602 to either of the chambers 606, 608 of the pneumatic cylinder 604. The directional control unit 626 is connected to the first chamber 606 by a first conduit 630 and the second chamber 608 by a second conduit 632. A first pressure gauge 634 and a first pressure relief valve 636 are associated with the first conduit 630. A second pressure gauge 638 and a second pressure relief valve 640 are associated with the second conduit 632. The first and second pressure gauges 634, 638 monitor the pressure held in the respective chambers 606, 608, and provide data used in determining the effective pressure differential between the chambers 606, 608. The first and second pressure relief valves 636, 640 ensure that any backpressure generated by the wave generation system does not exceed safe operating limits.

The directional control valve 628 is operable to change the directional force acting on the piston 610 by directing the pressurized air to either the first chamber 606 or the second chamber 608 and venting the other chamber. For example, the directional force acting on the piston 610 may either cause the piston 610 to push the second end 348 of the transfer arm 318 upward or to pull the second end 348 of the transfer arm 318 downward. In this embodiment, to push the second end 348 upward, the directional control valve 628 will direct pressurized air into the second chamber 608. In conjunction with the pressurization of the second chamber 608, pressurized air within the first chamber 606 may be vented through the directional control valve 628 to the atmosphere. Alternatively, to pull the second end 348 downward, the directional control valve 628 will direct pressurized air into the first chamber 606. In conjunction with the pressurization of the first chamber 606, pressurized air within the second chamber 608 may be vented through the directional control valve 628 to the atmosphere. The directional control valve 628 controls whether the piston pulls or pushes the second end 348 by directing pressurized air into either the first or second chamber 606, 608, and thereby, controlling the direction of the force acting on the piston 610. Exhaust vents (not shown) may further be used to govern the rate air is vented to the atmosphere to control the speed at which the piston 610 moves.

In one embodiment, the directional control valve 628 may be spring loaded and controlled by a solenoid by and on-delay/off-delay timing relay 642. The timing relay 642 supplies power to the directional control valve 628, i.e., the solenoid, for a predetermined time causing the directional control valve 628 to be in a first position. When power is removed, the spring corresponding to the directional control valve 628 causes the directional control valve 628 to move to a second position. Thus, the directional control valve 628 alternates between the first position and the second position based on whether power is supplied by the timing relay 642. Additionally, the time period the directional control valve 628 is in either the first position or the second position depends on the timing relay 642. In one embodiment, the second position is the default position of the directional control valve 628 when no power is being supplied. In a specific, non-limiting embodiment, the directional control valve 628 is in the first position when power is supplied. The first position directs pressurized air into the first chamber 606 while venting the second conduit 632 to the atmosphere. When power is removed, the directional control valve 628 is moved to the second position by the spring, directing pressurized air into the second chamber 608 while venting the first conduit 630 to the atmosphere. While a solenoid and a spring have been described as moving the directional control valve 628, one should appreciate there are a number of different mechanisms that may be utilized in moving the directional control valve 628 between positions. In another specific, non-limiting example, the pneumatic cylinder 604 may be a single-acting piston instead of a double-acting piston and the directional control valve 628 may use a three-port valve instead of a five-port valve. In one embodiment, the directional control valve 628 may be a five port, two position, solenoid controlled, spring loaded valve. In another embodiment, the directional control valve 628 could be pneumatically controlled. Additionally, the timing relay 642 may be a pendulum configuration that hits an electrical switch according to a timer.

Referring again to the pressure control valve 622 and the flow control valve 624, the pressure control valve 622 and flow control valve 624 function to act as an additional mechanism for ensuring the system pressure levels stay within its operational safety ratings and to provide additional governance over the speed at which the piston 610 moves by governing the pressure and flow rate of the pressurized air being delivered to the directional control unit 626. A gauge 644 may monitor the pressure of the pressurized air exiting the flow control valve 624 before entering the directional control unit 626.

The transfer arm 318 may be pivoted operationally between a lower engaged position and an upper disengaged position. The input source 364 raises the second end 348 of the transfer arm 318 to lower the first end 317 of the transfer arm 318 into the engaged position such that a substantial portion of the displacement block 304 is submerged in the water 106 thereby increasing displacement of the block 304 as described above. The input source 364 then lowers the second end 348 of the transfer arm 318 to raise the first end 317 of the transfer arm 318 into the disengaged position such that a substantial portion of the displacement block 304 is lifted from the water 106 thereby decreasing displacement of the block 304 as described above. Thus, the operational range of movement between the engaged position and the disengaged position for the transfer arm 318 where connected to the plunger rod 314 is controlled to generate a desired wave height of the wave in the tank 301.

Referring still to FIG. 3, but more specifically to FIGS. 3A and 3B, the wave generation system 302 includes a first spring member 370 operably associated with the transfer arm 318 and a second spring member 374 operably associated with the transfer arm 318. In the embodiment of the wave generation system 302 as illustrated, the first and second spring members 370, 374 are each a set of opposing magnets that exert substantial repelling forces on the transfer arm 318 which bias the transfer arm 318 and the displacement block 304 in either a downward or upward direction as the transfer arm 318 moves from the engaged position to the disengaged position and back.

The first spring member 370 includes a set of lower magnets 380 and a set of upper magnets 382. Each of the upper magnets 382 is mounted to a support member 384 that is affixed relative to the base 322. Each of the lower magnets 380 is positioned on a plate 388 that is mounted to an upper surface of the transfer arm 318. In one embodiment, each of the lower magnets 380 is located an equal distance from the transfer arm 318, and each of the lower magnets 380 is aligned below one of the upper magnets 382. The orientation of each lower magnet 380 relative to the corresponding upper magnet 382 is such that like poles of the magnets face one another. This orientation of the magnets results in a repulsive biasing force between the lower magnets 380 and the upper magnets 382. The biasing force is directed downwardly on the plate 388 and, therefore, increasing against the transfer arm 318 as the transfer arm 318 moves upward, i.e., a downward biasing force. The downward biasing force varies depending on the distance between the corresponding lower and upper magnets 380, 382, which is dependent on the position of the transfer arm 318. When the transfer arm 318 is in the engaged position (see FIG. 2A), the distance between the corresponding lower and upper magnets 380, 382 is greatest such that the downward biasing force between the magnets is at a minimum value. As the transfer arm 318 moves toward the disengaged position, the distance between the corresponding lower and upper magnets 380, 382 decreases to the smallest value, e.g., approximately ⅛ inch, such that the downward biasing force increases to a maximum value.

The second spring member 374 includes a plurality of lower magnets 390 and a plurality of upper magnets 392. Each of the upper magnets 392 is mounted to the support block 326 or to a plate (not shown) that is connected to the support block 326. Each of the lower magnets 390 is connected to the base 322 or to a plate (not shown) that is connected to the base 322. The orientation of each lower magnet 390 relative to the corresponding upper magnet 392 is such that like poles of the magnets face one another. This orientation of the magnets results in a repulsive biasing force between the lower magnets 390 and the upper magnets 392. The biasing force is directed upwardly on the support block 326, and, therefore, increasing against the transfer arm 318 as the transfer arm 318 moves downward, i.e., an upward biasing force. The upward biasing force varies depending on the distance between the corresponding lower and upper magnets 390, 392, which is dependent on the position of the transfer arm 318. When the transfer arm 318 is in the disengaged position (see FIG. 2B), the distance between the corresponding lower and upper magnets 390, 392 is greatest, such that the upward biasing force between the magnets is at a minimum value. As the transfer arm 318 moves toward the engaged position, the distance between the corresponding lower and upper magnets 390, 392 decreases to the smallest value, e.g., approximately ⅛ inch, such that the upward biasing force increases to a maximum value.

The strength of each magnet and the number of magnets used with each spring member may vary depending on the biasing forces required to accommodate the length and weight of the transfer arm, the weight and positioning of the displacement block, and the positioning of the axis of rotation about which the transfer arm is able to rotate as described above. Based on these same parameters, the positioning of the first spring member 370 and second spring member 374 may vary along the transfer arm 318 from the axis of rotation, but have been set as indicated in Table I. Each of the magnets 380, 382, 390, 392 may be a combination permanent neodymium magnet having a flux density and a pull force as indicated in Table I. Any number of neodymium magnets may be positioned side by side to form a magnetic bar to provide the necessary magnetic strength required for larger configurations of the wave generation system 302.

The wave generation system 302 further includes a first counterweight plate 354 on the first portion 344 of the transfer arm 318. Similarly, a second counterweight plate 358 is positioned on the second portion 348 of the transfer arm 318. Additional counterweights 356 may be positioned on the first counterweight plate 354, but initially no additional weight is positioned on the second counterweight plate 358. Additional counterweights 360 may be positioned on the second counterweight plate 358 when the transfer arm 318 is balanced as described below. The amount of additional counterweight positioned on each side of the axis of rotation of the transfer arm 318 may vary based on several design parameters, including the distance the counterweight is positioned from the axis of rotation, to achieve the desired balance. One goal of using counterweights on opposite sides of the axis of rotation is to balance the transfer arm 318 to a substantially neutral position in which the transfer arm 318 is substantially level in a neutral position.

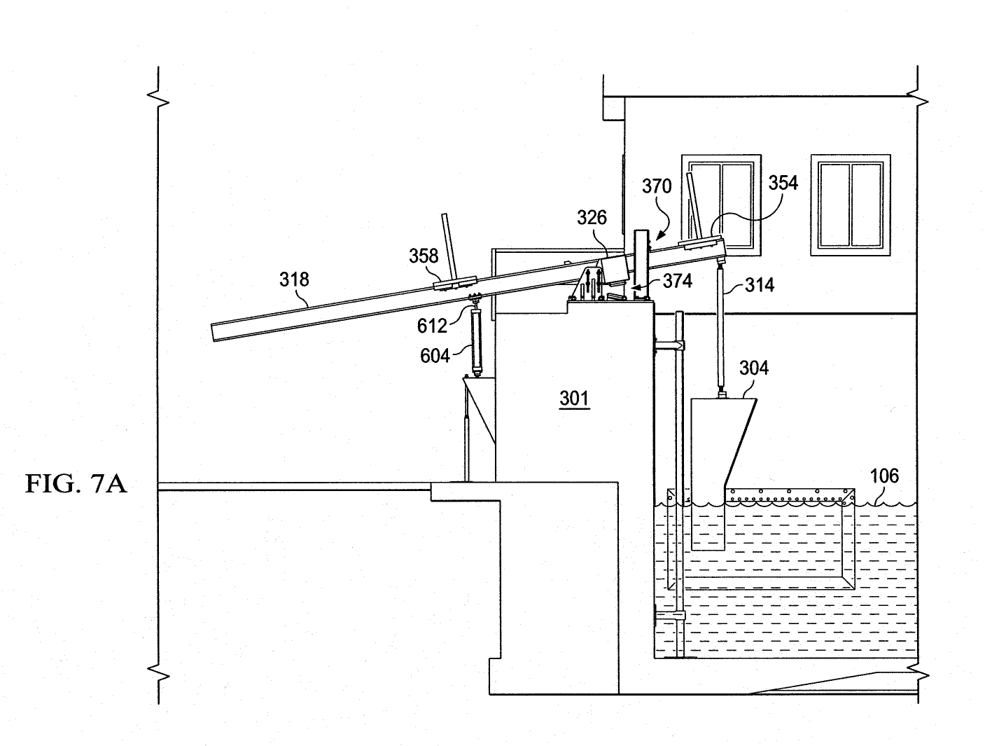

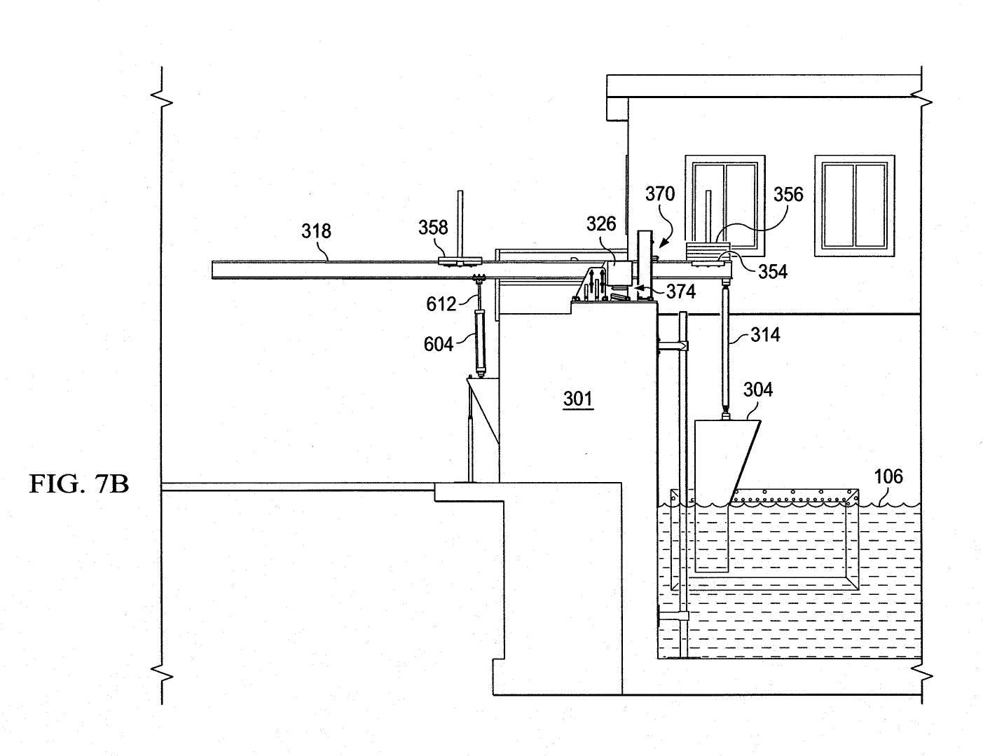

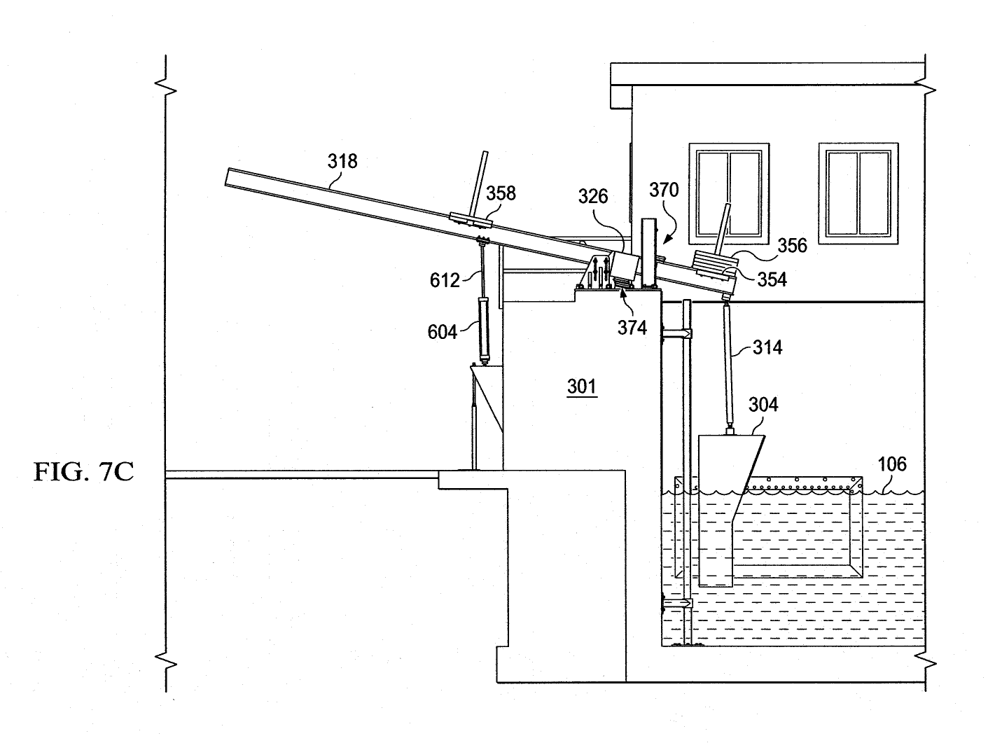

The wave generation system 302 is designed to generate standing waves as defined above. To start generating standing waves in the tank 301, the transfer arm 318 is dynamically balanced before commencing oscillations of the displacement block 304 in the water 106. This involves using the counterweights to balance the transfer arm 318 when loaded with the displacement block 304 and as the transfer arm 318 moves between the engaged and disengaged positions against the spring members 370, 374. Referring more specifically to FIGS. 7A, 7B, and 7C, dynamic balancing is accomplished by first leveling the transfer arm 318 with no counterweights on the second portion 348 of the transfer arm 318 and without the displacement block 304 being attached by moving the second counterweight plate 358 closer or farther away from the pivotal axis of the transfer arm 318. The tank 301 is then filled so that the displacement block 304 floats upwardly to a position in the tank 301 where it can be attached to the plunger rod 314 when the transfer arm 318 is still level in the neutral position. As the water 106 continues to rise in the tank 301, the displacement block 304 continues to rise and lift the transfer arm 318 to the fully disengaged position as shown in FIG. 7A. When the transfer arm 318 reaches the fully disengaged position, the water 106 has reached the desired depth in the tank 301 to accommodate the wave base.

Additional weight 356 (x lbs.) is then added to the first counterweight plate 354 until the transfer arm 318 returns to the neutral position as shown in FIG. 7B. When the transfer arm 318 reaches the neutral position, the weight positioned on the first counterweight plate 354 is doubled (2× lbs.) which forces the displacement block 304 deeper into the water 106 as the transfer arm 318 moves downwardly toward the engaged position as shown in FIG. 7C. Additional weight (y lbs.) is then placed on the second counterweight plate 358 to counterbalance the additional weight positioned on the first counterweight plate 354 in order to return the transfer arm 318 back to the neutral position. When the transfer arm 318 again reaches the neutral position, the weight positioned on the first counterweight plate 354 is again doubled (4× lbs.) which forces the displacement block 304 even deeper into the water 106 such that the transfer arm 318 moves downwardly towards the fully engaged position described above where the repulsive force between the lower and upper magnets 390, 392 is close to its maximum value. Additional weight (z lbs.) is then placed on the second counterweight plate 358 to again counterbalance the additional weight position on the first counterweight plate 354 in order to return the transfer arm 318 back to the neutral position. When the transfer arm 318 again reaches the neutral position, the transfer arm 318 is considered to be dynamically balanced with the displacement block 304 and ready to begin generating waves propagating in a linear direction within the tank 301. It should be understood that additional weight may be added to the first counterweight plate 354 in other incremental values to facilitate the balancing process.

After the transfer arm 118 has been balanced with the appropriate amount of counterweight, the input source 164 may commence moving the transfer arm 118 between the engaged and disengaged position to generate a series of waves propagating linearly in the tank 301 as described above. The number of standing waves generated in the tank 301 is determined by the frequency of the oscillating displacement block in the water 106. As the frequency and number of strokes per minute is increased, the number of standing waves can be incrementally increased in the tank 301 as desired. For example, using the data in Table I for the wave generation system 302, two, three foot waves were generated in the tank 301 over approximately three to four minutes at the frequency indicated below in Table IV. To generate three and four wave systems as also shown in FIGS. 1A-1C, the frequencies listed in Table IV were used. For example, the displacement block 304 must oscillate at a rate of 6.41 strokes per minute (a frequency of 0.107 Hz) for a period of approximately three minutes to generate two waves having a height of approximately three foot per standing wave peak.

TABLE IV
Block Generates 3 Foot Wave

Numbering of Standing Waves

| Operational Characteristics | 2 waves | 3 waves | 4 waves |
|---|---|---|---|
| Wave Period (sec) | 9.36 | 6.40 | 4.98 |
| Wave Frequency (Hz) | 0.107 | 0.156 | 0.201 |
| Strokes/minute | 6.41 | 9.37 | 12.05 |
| Total Initiating Strokes | 19.23 | 28.11 | 36.15 |

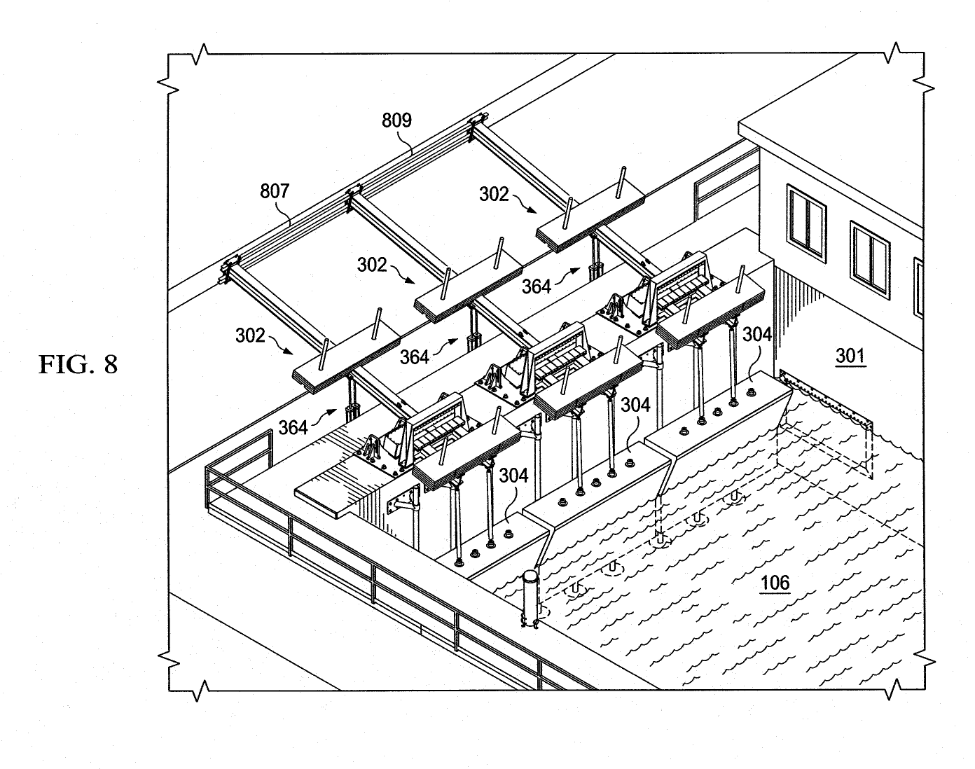

Referring to FIG. 8, three wave generation systems 302 are shown in position side-by-side such that the displacement blocks 304 are aligned end-to-end to simulate a displacement block having a single face, partially flat and partially angled displacement block 304, to generate standing waves having three times the width of one of the displacement blocks 304. The oscillating motion of the three displacement blocks 304 is synchronized by beams 807, 809 that rigidly connect the second end 319 of each transfer arm 318. One or more input sources 364 may then be connected to the beams 807, 809 or any one of the transfer arms 318 to move the displacement blocks 304 up-and-down in a synchronized fashion as a single displacement block 304. It should be understood that any number of wave generation systems 302 may be utilized to increase the width of the standing wave being generated in the tank 301.

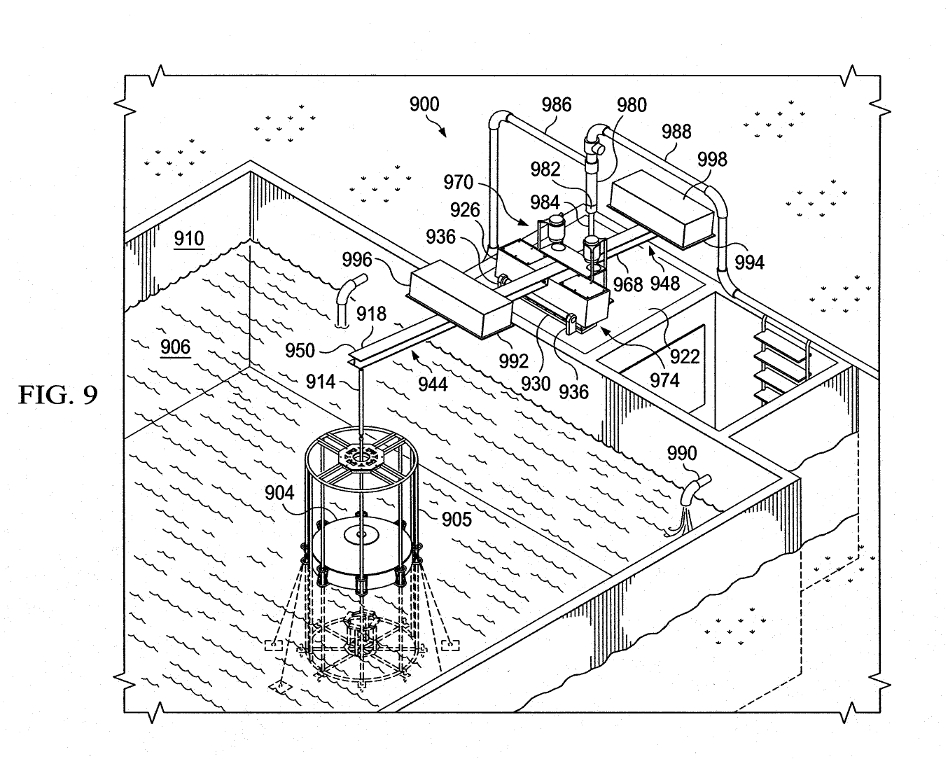

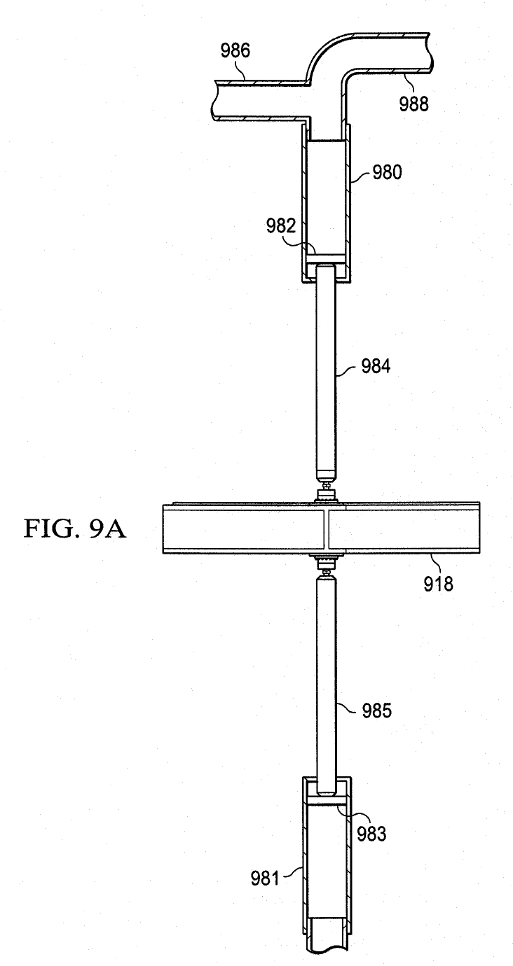

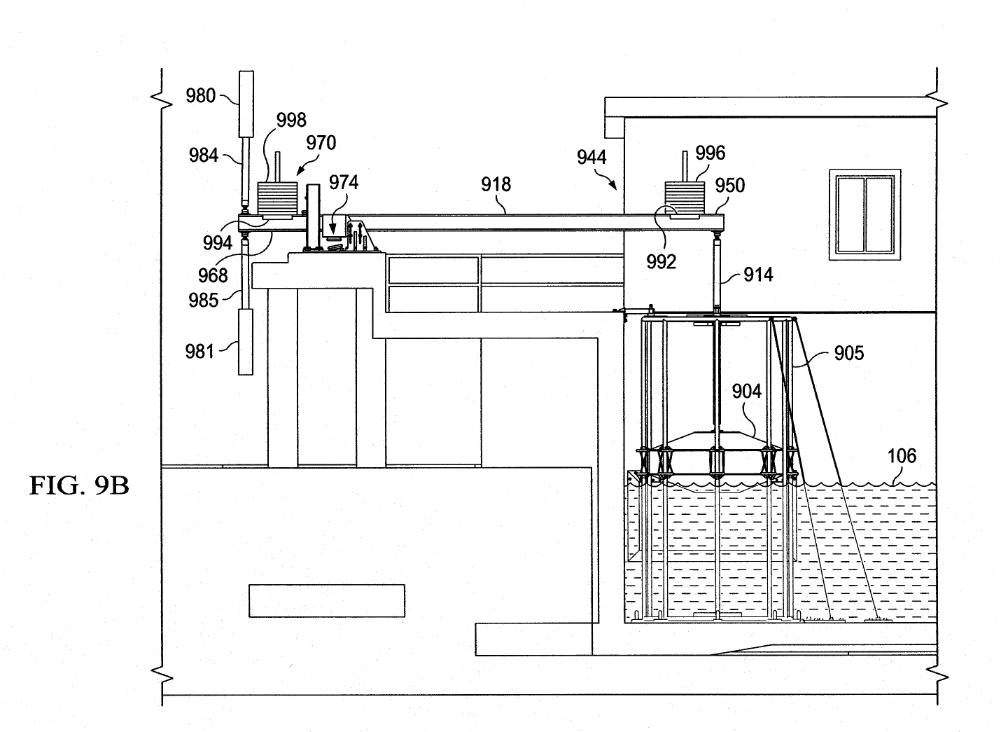

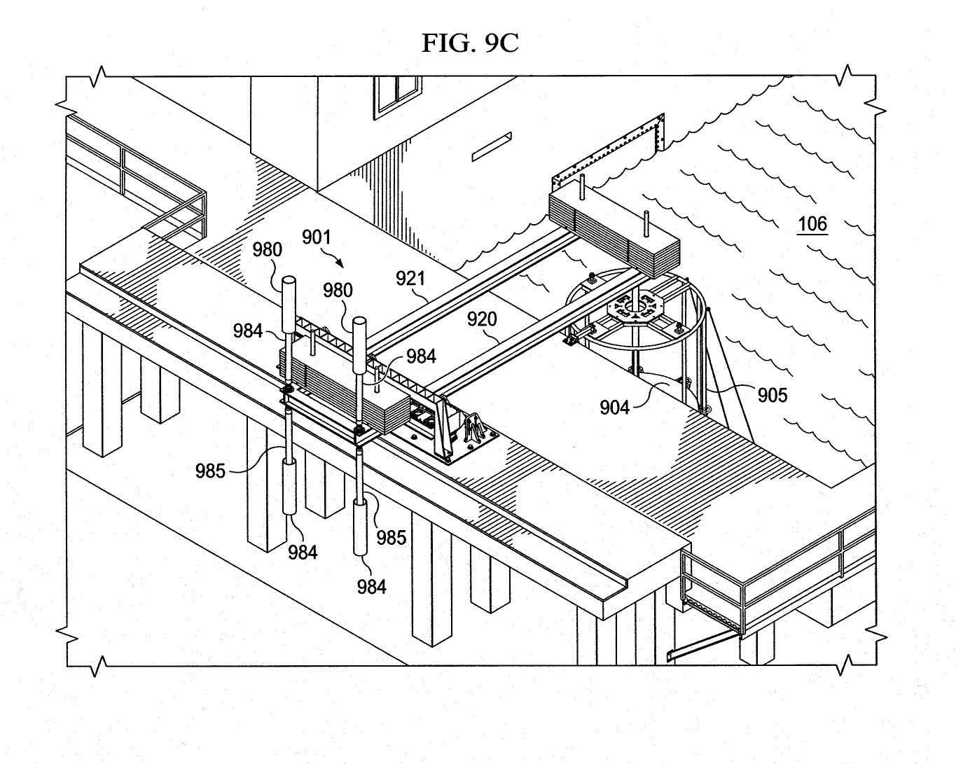

Referring to FIG. 9, a wave capture system, or fulcrum motor system, 900 includes a buoyancy block 904 that reciprocally moves within a buoyancy block cage 905 in response to waves in a tank 910 containing a liquid or water 906. The buoyancy block cage 905 is fixed to the bottom of the tank 910 while the buoyancy block 904 is connected by a rod 914 to a transfer arm 918. The transfer arm 918 is pivotally attached to a base 922. In the embodiment illustrated in FIG. 9, the base 922 is stationary relative to the tank 910 and does not follow the motion of waves in the liquid 906.

The pivotal connection of the transfer arm 918 to the base 922 is similar in structure and operation to the transfer arm 118 and base 122, which are illustrated in FIGS. 1-3. The transfer arm 918 is rigidly connected to a support block 926 similar to the support block 126, and the support block 926 is pivotally connected by one or more hinges 930 to supports 936 secured to the base 922. The pivotal connection provided by the hinge 930 allows the transfer arm 918 to rotate relative to the base 922 about an axis of rotation passing through the hinge or hinges 930. In the embodiment illustrated in FIG. 9, the presence of the support block 926 permits the axis of rotation to be offset from the transfer arm 918 by an amount approximately equal to the height of the support block 926. As previously mentioned with respect to the wave generation system 102, the hinges used to provide pivotal connection of the transfer arm 918 may be any type of hinge or other device that allows pivotal or rotational connection between two objects.

Similar to the transfer arm 118 of FIG. 1, the transfer arm 918 is preferably an elongated beam member or arm that includes a first portion 944 positioned on one side of the axis of rotation and a second portion 948 on an opposite side of the axis of rotation. In one embodiment, the buoyancy block 904 is connected to the first portion 944 of the transfer arm 918 at or near a first end 950 of the transfer arm 918. While the buoyancy block 904 may be located at the first end 950 of the transfer arm 918, the buoyancy block may be positioned and connected along the transfer arm 918 at another location in the first portion 944 closer to the hinge 930. One difference between the transfer arm 918 and the previously-described transfer arm 118 is that the first portion 944 of the transfer arm 918 is typically longer than second portion 948. As described in more detail below, configuring the transfer arm 918 in this way allows the buoyancy block 904 to receive the mechanical advantage associated with a lever to enhance the effective mechanical advantage as described for the wave generation system 302.

Unlike the wave generation system 102, the wave capture system 900 does not include an input source to drive a second end 968 of the transfer arm. Instead, the transfer arm 918 is driven on the first portion 944 of the transfer arm 918 at or near the first end 950 by the buoyancy block 904, which is responsive to waves in the tank 910. The up-and-down, reciprocal motion of the buoyancy block 904 drives the transfer arm 918 between a first, or upper position and a second, or lower position. In the upper position, the first end 950 of the transfer arm 918 is positioned upward such as when the buoyancy block 904 has ridden to the crest of a wave. In this upper position, the second end 968 of the transfer arm 918 is lower than the first end 950. In the lower position, the first end 950 of the transfer arm 918 is positioned downward such as when the buoyancy block 904 has ridden down within the trough of a wave. In this lower position, the second end 968 of the transfer arm 918 is higher than the first end 950.

Referring still to FIG. 9, but also to FIGS. 9A and 9B, the wave capture system 900 includes an upper piston cylinder 980 and a lower piston cylinder 981 (not shown in FIG. 9), both the piston cylinders 980, 981 being connected to or affixed relative to the base 922. An upper piston shaft 984 and a lower piston shaft 985 are each operably connected to the second portion 948 of the transfer arm 918. The piston shafts 984, 985 are preferably connected to the transfer arm 918 such that a distance between the axis of rotation (of the transfer arm 918) and the piston shafts 984, 985 is less than a distance between the axis of rotation and the buoyancy block 904. The upper piston shaft 984 is connected to an upper piston 982 positioned in the upper piston cylinder 980, and the lower piston shaft 985 is connected to a lower piston 983 positioned in the lower piston cylinder 981. In one embodiment, the connection between the piston shafts 984, 985 and the transfer arm 918 may be by way of a fitting that allows rotational movement, such as a ball fitting. A similar fitting may be used to connect the piston shafts 984, 985 to the pistons 982, 983. The wave capture system 900 may be configured with additional pistons and piston cylinders disposed along the transfer arm 918. Referring to FIG. 9C, the wave capture system 900 has a pair of cylinders 980, 981 and piston rods 984, 985. The wave capture system 900 further comprises two transfer arms 920, 921 operably connected to one buoyancy block 904 where each transfer arm 920, 921 is capable of being connected to one or multiple piston rods 985 as previously described.

Referring again to FIG. 9, an intake conduit 986 is fluidly connected between the tank 910 and the upper piston cylinder 980. The intake conduit 986 is capable of delivering the liquid 906 to the upper piston cylinder 980 through a one-way check valve (not shown) as the transfer arm 918 is moved into the upper position (i.e. thereby moving the second portion 948 of the transfer arm 918 downward and forcing fluid out of the upper piston cylinder 980 through a one-way check valve (not shown)). An outlet conduit 988 is fluidly connected between the upper piston cylinder 980 and a turbine or other generator for generating electricity due to the flow of the liquid 906. The outlet conduit 988 is capable of delivering the liquid 906 through a one-way check valve (not shown) to the turbine as the transfer arm 918 is moved into the lower position (i.e. thereby moving the second portion 948 of the transfer arm 918 upward and drawing fluid through a one-way check valve (not shown), into the upper piston cylinder 980). As an alternative to generating electricity, the wave capture system 900 may simply be used to impart mechanical energy to the liquid in the piston cylinder. This may be done to move the liquid from one location to another. The energy imparted to the liquid can be harnessed immediately or at a later time. It should also be understood that while the wave capture system 900 is described as pressurizing or moving a liquid, alternatively, a gas such as air could be drawn into and pushed out of the piston cylinders. The term “fluid” as used herein refers to either a liquid or gas or some combination of a liquid and gas.

Although not fully illustrated in FIGS. 9 and 9A, a similar intake conduit and outlet conduit is fluidly connected to the lower piston cylinder 981. The intake conduit connected to the lower piston cylinder 981 allows the liquid 906 from the tank 910 to travel through a one-way check valve (not shown) to the lower piston cylinder 981 as the transfer arm 918 is moved into the lower position (i.e. thereby moving the second portion 948 of the transfer arm 918 upward). The outlet conduit that is fluidly connected to the lower piston cylinder 981 routes liquid from the lower piston cylinder 981 to either a turbine or possibly back to the tank 910 through a return-flow conduit 990 to maintain circulation within the tank 910. The outlet conduit associated with the lower piston cylinder 981 is capable of delivering the liquid 906 from the lower piston cylinder 981 as the transfer arm 918 is moved into the upper position (i.e. thereby moving the second portion 948 of the transfer arm 918 downward). The fluid moved by the reciprocating action of the pistons 982, 983 may be drawn from a source other than the tank 910

The wave capture system 900 includes a first spring member 970 operably associated with the transfer arm 918 and a second spring member 974 operably associated with the transfer arm 918. The first and second spring members 970, 974 are structurally and operationally similar to the spring members 170, 174 described previously and used with the wave generation system 102. Both of the spring members 970, 974 may include upper and lower magnets that repel one another and provide biasing forces to the transfer arm 918. The biasing force varies depending on the distance between the corresponding lower and upper magnets, which is dependent on the position of the transfer arm 918.

In one embodiment, the strength of the lower and upper magnets of the first spring member 970 is approximately 1170 pounds per magnet. In this embodiment, the strength of the lower and upper magnets of the second spring member 974 is approximately 1170 pounds per magnet. The strength of each magnet and the number of magnets used with each spring member may vary depending on the length and weight of the transfer arm, the weight and positioning of the buoyancy block, and the positioning of the axis of rotation about which the transfer arm is able to rotate. Based on these same parameters, the positioning of the first spring member 970 and second spring member 974 may vary along the transfer arm 918 from the axis of rotation. As with the spring members described previously, alternative spring components may be used with the wave capture system 900. Possible alternatives include, without limitation, mechanical springs, electro-magnetic springs, visco-elastic springs, or any other type of spring system.

Referring still to FIG. 9, the wave capture system 900 may further include one or more counterweight plates 992 on the first portion 944 of the transfer arm 918. Similarly, one or more counterweight plates 994 may be positioned on the second portion 948 of the transfer arm 918. In the embodiment of FIG. 9, counterweights 996 are positioned on the counterweight plate 992, and counterweights 998 are positioned on the counterweight plate 994. The amount of counterweight positioned on each side of the axis of rotation of the transfer arm 918 may vary based on many design parameters, including the distance the counterweight is positioned form the axis of rotation. One goal of using counterweight on opposite sides of the axis of rotation is to balance the transfer arm 918 to a substantially neutral position when not in operation. In the neutral position, the transfer arm 918 is substantially level. As previously discussed, another possible benefit of the use of counterweights is the increase in mechanical advantage associated with the transfer arm 918 as described above.

In operation, the wave capture system 900 is capable of converting wave energy from the liquid into hydraulic, mechanical, or electrical energy by pumping the liquid 906 with the pistons 982, 983. As the buoyancy block 904 rides upon waves in the tank 910 (becoming at least partially submerged at times), the transfer arm 918 is reciprocally moved between the upper and lower positions. As the first end 950 of the transfer arm 918 is moved upward by the buoyancy block 904, the second end 968 travels downward. During this downward stroke of the second end 968, the liquid 906 (or another operating fluid) is drawn into the upper piston cylinder 980 and any of the liquid 906 or other fluid in the lower piston cylinder 981 is forced from the lower piston cylinder 981. As the first end 950 of the transfer arm 918 moves downward with the buoyancy block 904, the second end 968 travels upward. During the upward stroke of the second end, the liquid 906 or other fluid in the upper piston cylinder 980 is forced out of the upper piston cylinder 980 and into the outlet conduit 988. The liquid 906 (or another operating fluid) is also drawn into the lower piston cylinder 981. The liquid 906 or other fluids that are forced from the upper and lower piston cylinders 980, 981 may be routed to a turbine or other generator for immediate generation of electricity. Alternatively, some or all of the fluid may be routed to a storage tank for later conversion to electricity. Still other possibilities include routing the fluid back to the tank 910 to maintain circulation of the liquid 906 in the tank 910, or simply moving the fluid from one location to another. If it is not desired to produce electricity, the wave capture system 900 may be used to impart a mechanical or hydraulic energy to the fluid that can be used to drive a wide variety of mechanical or hydraulic devices.

The buoyancy block 904 and piston arrangement described above operate similarly to the buoyancy pump devices and buoyancy pump power systems described in applicant's commonly-owned U.S. Pat. Nos. 6,953,328; 7,059,123, 7,258,532; 7,257,946; 7,331,174; 7,584,609; 7,735,317; 7,737,572 and U.S. patent application Ser. Nos. 12/775,357 and 12/775,375, all of which are hereby incorporated by reference. One of the differences in structure and operation of the wave capture system 900 is that the connection between the buoyancy block 904 and the piston shafts 984, 985 is more indirect via the transfer arm 918. The presence of the transfer arm provides mechanical leverage with respect to the forces imparted by the buoyancy block 904 on the transfer arm 918 and thus the piston shafts 984, 985 as described above. The shape and size of the buoyancy block may be varied depending on the size and shape of the tank in which the wave generation system is operating and depending on the wave profile that is desired in the tank.

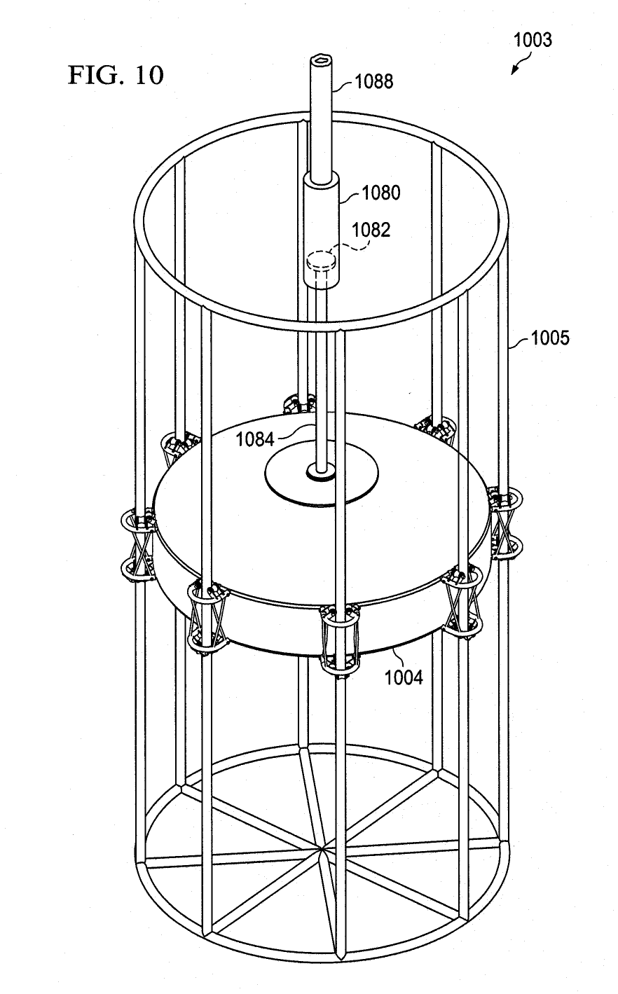

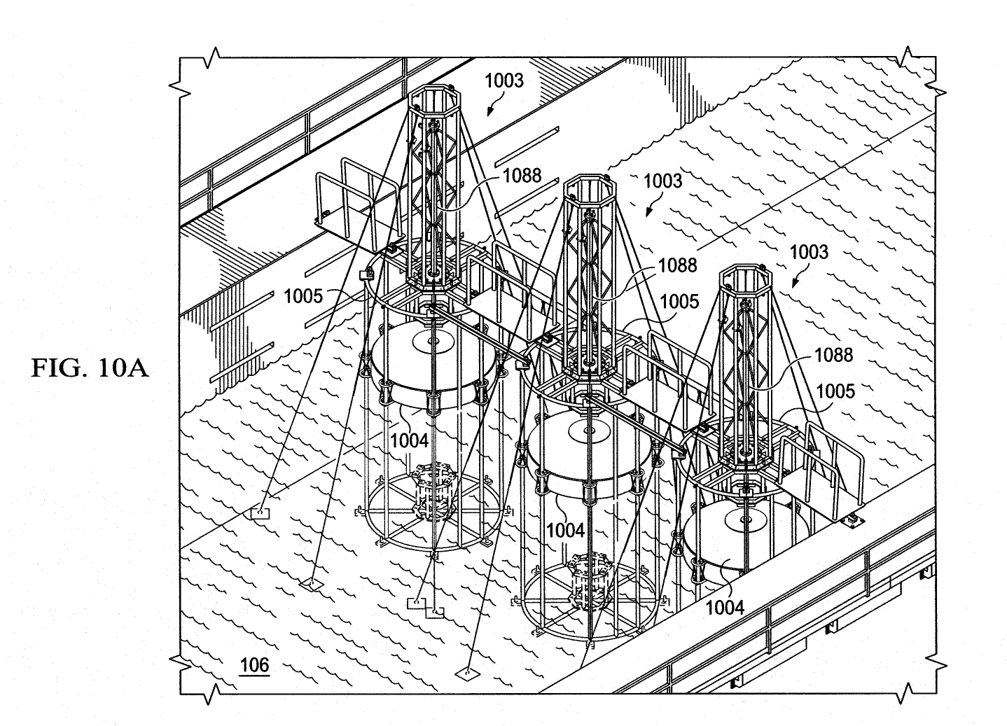

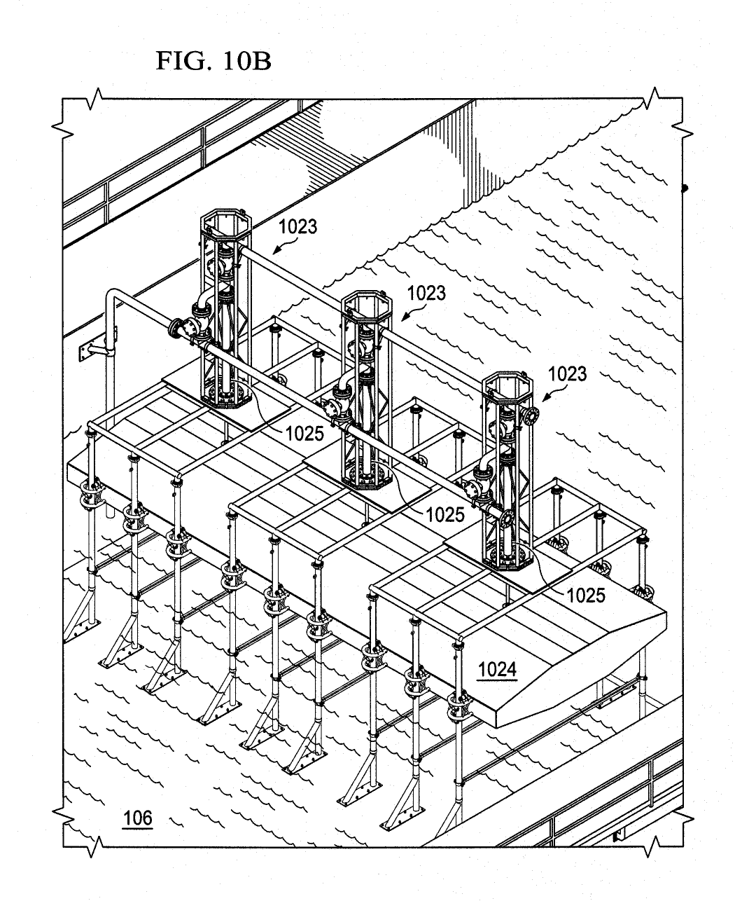

Referring to FIG. 10, a buoyancy block device 1003 as described in U.S. Pat. No. 6,953,328 comprises a buoyancy block 1004 disposed within a buoyancy block housing 1005 which defines a buoyancy chamber therein through which the fluid may flow. The buoyancy block 1004 is disposed within the buoyancy chamber to move axially therein in a first direction responsive to rising of the fluid in the buoyancy chamber and a second direction responsive to lowering of the fluid in the buoyancy chamber. The buoyancy block device 1003 also comprises at least one piston cylinder 1080 similar to the upper piston cylinder 980 shown in FIG. 9A which is rigidly connected to the buoyancy block housing 1005 and has at least one valve disposed therein (not shown) operating as an inlet in response to movement of the buoyancy block 1004 in the second direction and an outlet in response to movement of the buoyancy block 1004 in the first direction. A piston 1082 similar to the piston 982 shown in FIG. 9A is slideably disposed within the piston cylinder 1080 and connected to the buoyancy block 1004 by a piston rod 1084 similar to the upper piston shaft 984 shown in FIG. 9A, the piston rod 1084 being moveable in the first and second directions. The buoyancy block device 1003 may also comprise a second cylinder, piston, and piston rod assembly (not shown) similar to the lower piston cylinder 981, the piston 983, and the lower piston shaft 985 shown in FIG. 9A connected to the other side of the buoyancy block 1004 to drive the transfer arm 918 in both directions.

Referring to FIG. 10A, three buoyancy pump devices 1003 are shown, each one similar to the buoyancy pump devices 105 positioned in the tank 101 as shown in FIG. 1 and described above. The buoyancy block devices 1003 are positioned side-by-side such that the buoyancy blocks 1004 are aligned and to capture the width of the standing wave generated by the wave generation systems 302 shown in FIG. 8 as the standing wave moves the buoyancy blocks 1004 up-and-down. For example, in the energy transfer system 300 utilizing three of the wave generation systems 302 each having the characteristics set forth in Table I, the pneumatic actuator 600 expended approximately 14.5 hp of energy to oscillate the displacement blocks 304 at a rate of 6.41 strokes per minute (a frequency of 0.107 Hz) for a total of approximately 60 strokes over a period of approximately three minutes. At this frequency, the displacement blocks 304 generated a two-wave standing wave pattern having a height of approximately three foot per wave as shown in FIG. 1A. After the pattern of three-foot standing waves was generated and began propagating back and forth along the length of the tank 301, the output of each of the three buoyancy block devices 1003 was calculated at approximately 2.5 hp as the pneumatic actuator 600 continued to oscillate the displacement blocks 304 utilizing an input of 14.5 hp.

The buoyancy blocks 1004 may be shaped such that the plurality of the buoyancy blocks 1004 behave as a single buoyancy block 1024 as shown in FIG. 10B. The buoyancy block 1024 oscillates all three piston assemblies 1025 simultaneously to capture the full width of the standing waves propagating past the buoyancy block devices 1023. The inputs and outputs of the three piston assemblies 1025 may be coupled together and function in the same fashion as the wave capture system 900 described above. The three piston assemblies 1025 may also function independently of each other depending on the application desired. It should be understood that any number of the buoyancy block devices 1023 may be utilized to capture the full width of the standing wave being generated in the tank 301.

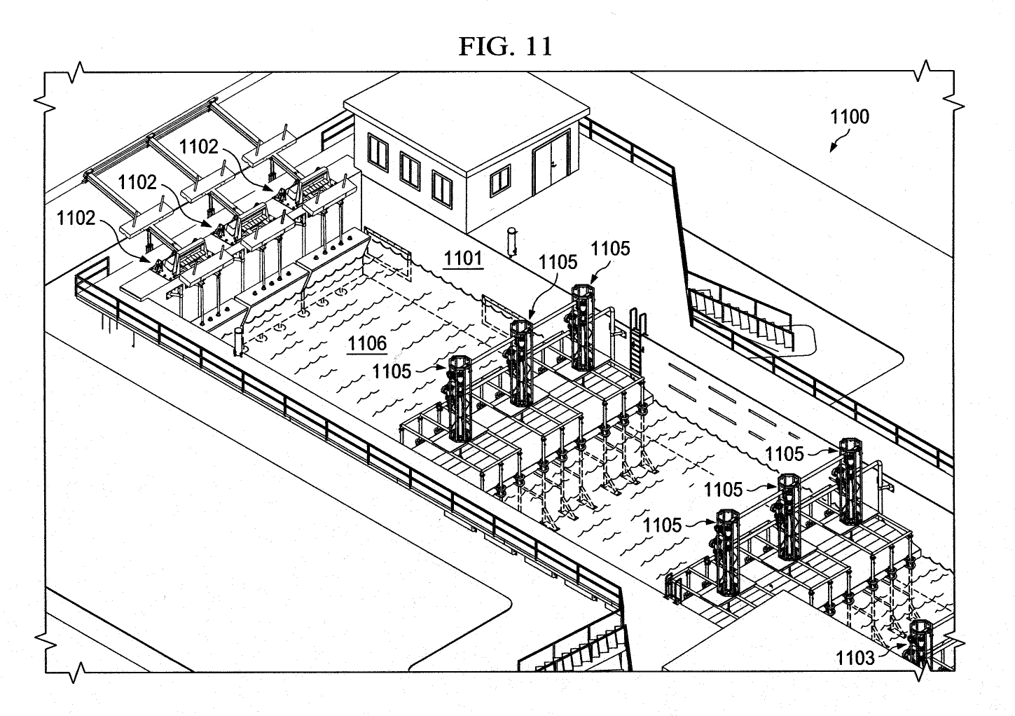

Referring to FIG. 11, an energy transfer system 1100 similar to the energy transfer system 100 is provided. The energy transfer system 1100 includes three rows of buoyancy pump devices 1105 similar to the buoyancy block devices 105 shown in FIG. 1 and the buoyancy block devices 1023 shown in FIG. 10B that are positioned throughout a land-based tank 1101. As previously mentioned, wave capture systems 103 and 900 may also be used in place of, or in combination with, the buoyancy pump devices 1105. The energy transfer system 1100 further comprises a row of wave generation systems 1102 is positioned at one end of the tank 1101. As previously described, the wave generation systems 1102 may be operated to generate various wave sizes, patterns, and profiles. In one example shown in FIG. 1C, the wave pattern generated includes three standing waves having four peaks, i.e., a first peak located adjacent the wave generation systems 1102 and three other peaks captured by the buoyancy pump devices 1105. Thus, the buoyancy pump devices 1105 are positioned at locations in the tank 101 where peaks of the standing waves are formed in the tank 1101 as the result of the wave generation systems 1102 moving displacement blocks 1104 up and down in water 1106.

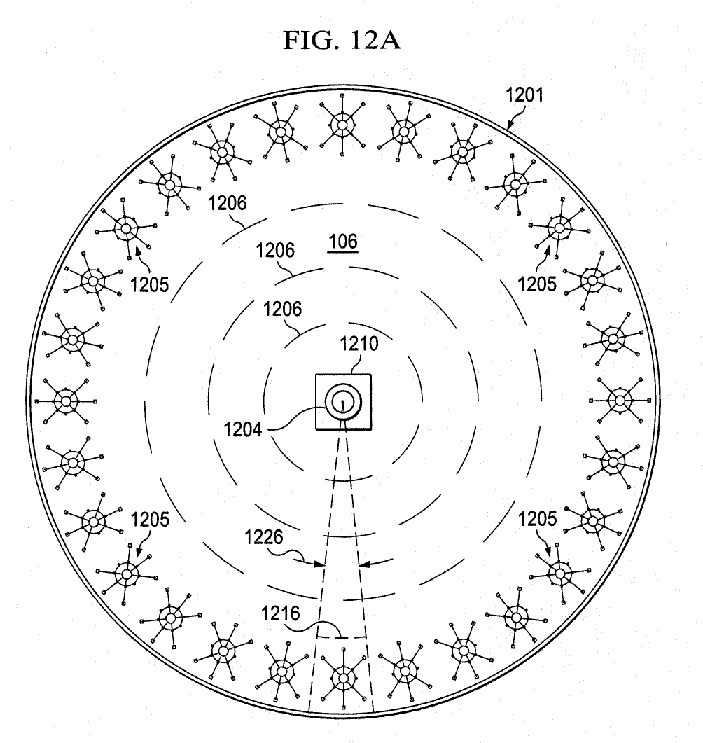

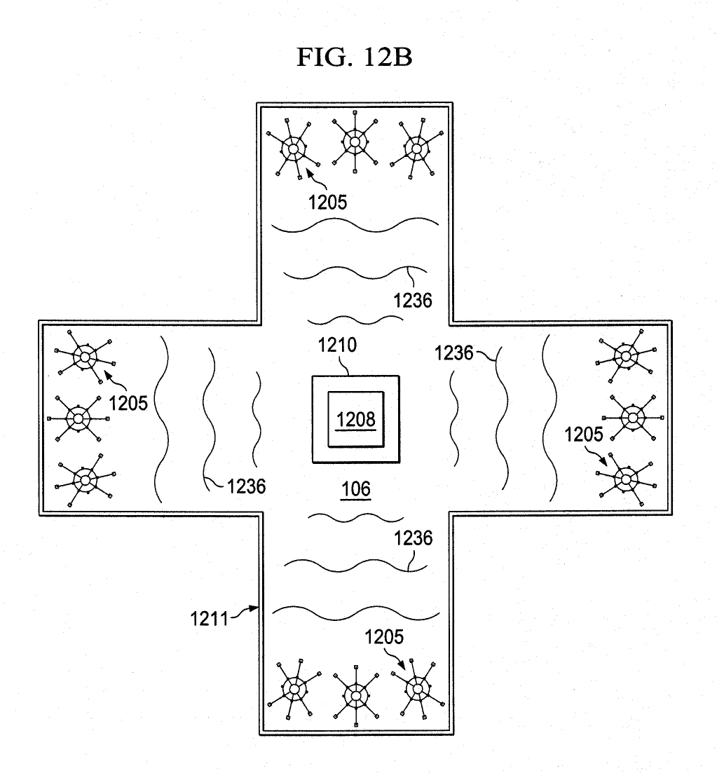

As indicated above, waves can travel for miles without significant dissipation so that the length of the tank 101 may be as long as desired to accommodate standing waves propagating in a generally linear direction within the tank 101. Although the tanks described above are generally rectangular in shape, tanks may be constructed in a variety of shapes to accommodate standing waves moving in a generally linear direction. For example, a bell-shaped displacement block 1204 may be positioned on a platform 1210 in the center of a circular tank 1201 with buoyancy powered devices 1205 or wave capture systems 1203 positioned around the perimeter of the circular tank 1201 as shown in FIG. 12A. Although the bell-shaped displacement block 1204 would generate a generally radial standing wave 1206, sectors of the standing wave would propagate in a generally linear direction with respect to the position of each of the individual buoyancy powered devices 1205 facing a generally straight wave front 1216 associated with that particular sector 1226 of the standing wave 1206. In another example, the displacement block may be a square-shaped displacement block 1208 positioned on the platform 1210 in the center of a cross-shaped tank 1211 as shown in FIG. 12B. Again, the square-shaped displacement block 1208 would generate standing waves 1236 in a generally linear direction to motivate the buoyancy powered devices 1205 positioned at the end of each arm of the tank 1211. It should be clear that the tank may be a variety of different geometric shapes as long as the standing wave propagates in a generally linear direction with respect to the wave capture systems.

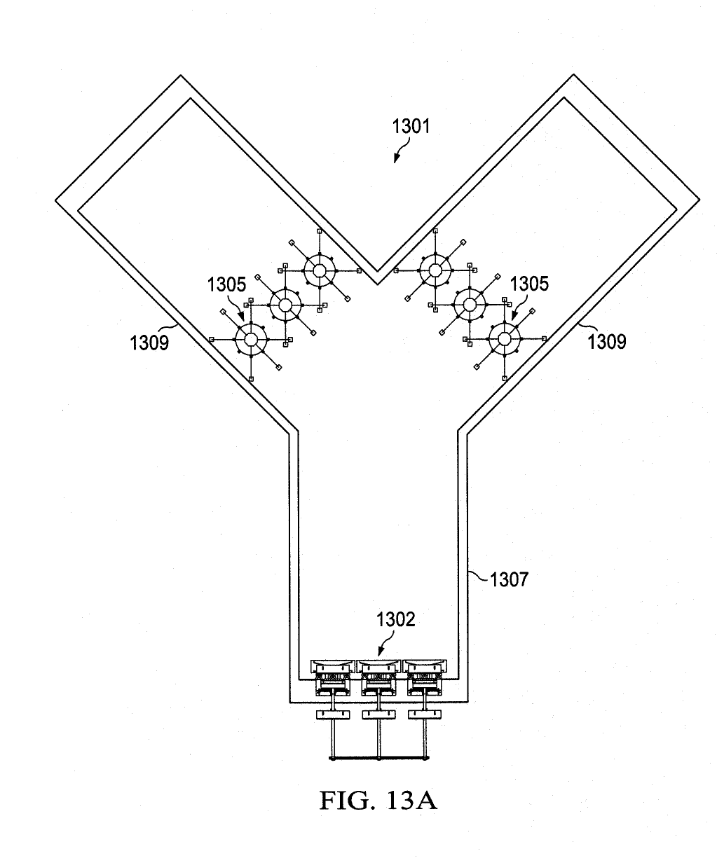

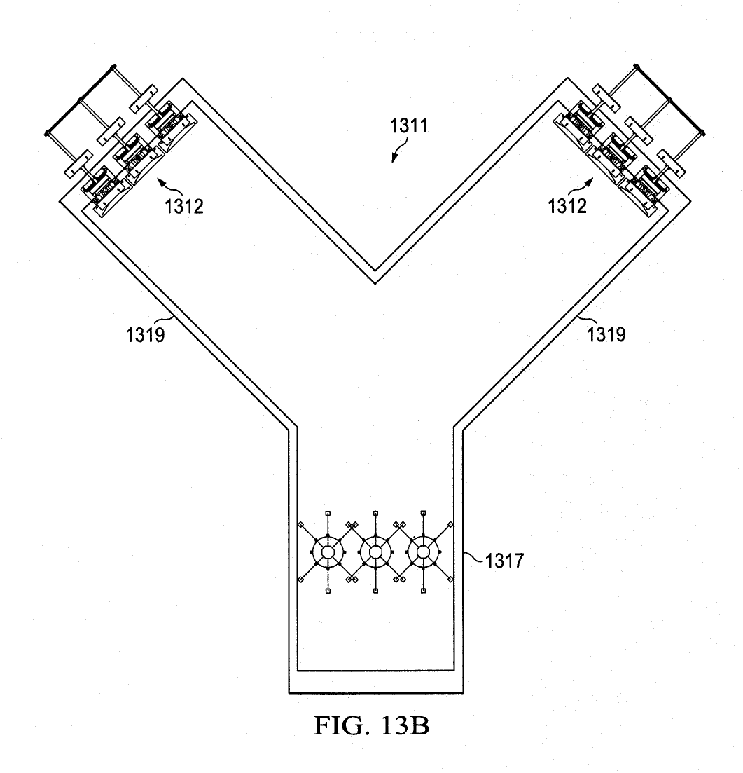

Tanks may also be other non-geometric shapes to accommodate standing waves propagating in a generally linear direction within the tank. Referring to FIG. 13A for example, a Y-shaped tank 1301 having a tail portion 1307 and two branch portions 1309 may be utilized as a standing wave splitter. A wave generation system 1302 is positioned in the tail portion 1307 of the tank 1301 and buoyancy powered devices 1305 are positioned in each of the two branch portions 1309 of the tank 1301. The wave generation system 1302 generates standing waves propagating toward the center of the Y-shaped tank 1301 that are split by the branch portions 1309 into two separate standing waves having a smaller wave height. Conversely, a Y-shaped tank 1311 shown in FIG. 13B also having a tail portion 1317 and to branch portions 1319 may be utilized as a standing wave concentrator. Wave generation systems 1312 are positioned in each of the branch portions 1319 of the tank 1311 and a single wave capture system 1313 is positioned in the tail portion 1317 of the tank 1311. In this case, each of the wave generation systems 1312 generate a separate series of standing waves propagating toward the center of the Y-shaped tank 1311 which may constructively interfere with each other to form a single series of standing waves having a greater wave height that is captured by the wave capture system 1313.

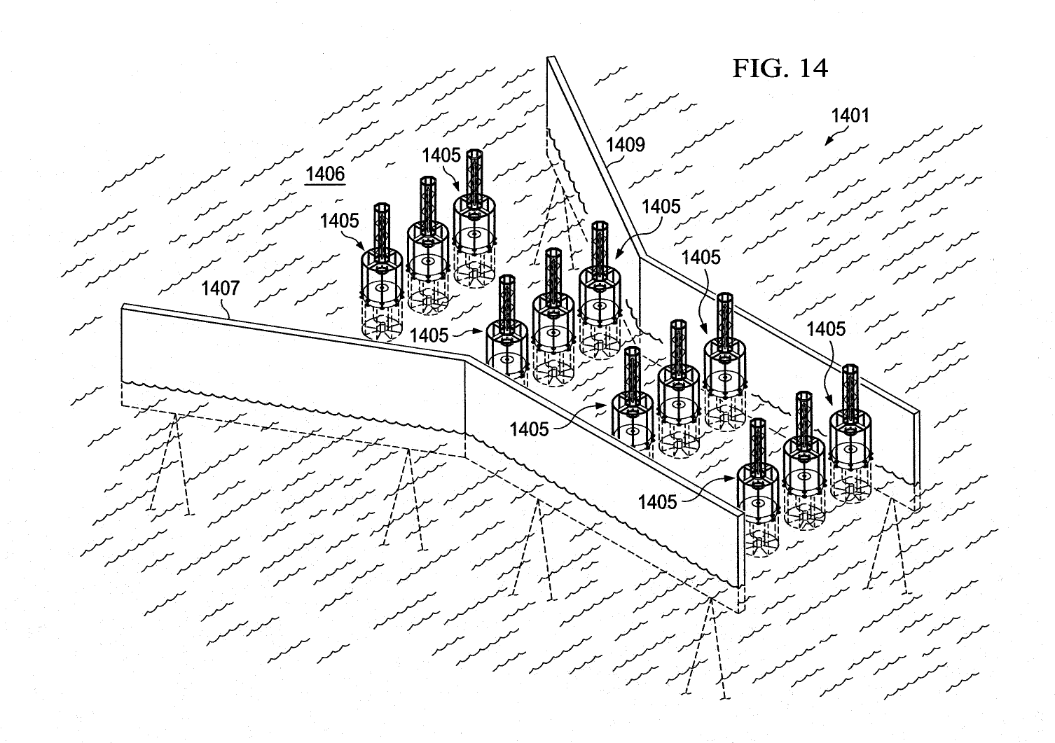

Although the tanks described are constructed in fixed shapes and sizes, tanks may also be formed or constructed with open ends in existing bodies of water such as streams, rivers, ponds, lakes or oceans for capturing omni-directional waves and defracting them to propagate in a generally linear direction within the tank. Referring to FIG. 14 for example, a Y-shaped tank 1401 is constructed from two vertical walls 1407, 1409 that float and have an upper portion extending sufficiently high above the surface of water 1406 to capture and contain the omni-directional waves that travel through the tank 1401. Buoyancy powered devices 1405 are positioned in the tank 1401 to capture the diffracted waves captured and formed by the vertical walls 1407, 1409 of the tank 1401. It should be clear from the foregoing, that the tank 1401 may have a variety of different shapes and orientations for capturing existing waves in existing bodies of water and guiding them in a generally linear direction without the use of wave generation systems. Although the tank 1401 is generally an open-ended configuration, one end of the tank 1401 may be fully or partially closed to reflect the waves back to the buoyancy block devices 1405.

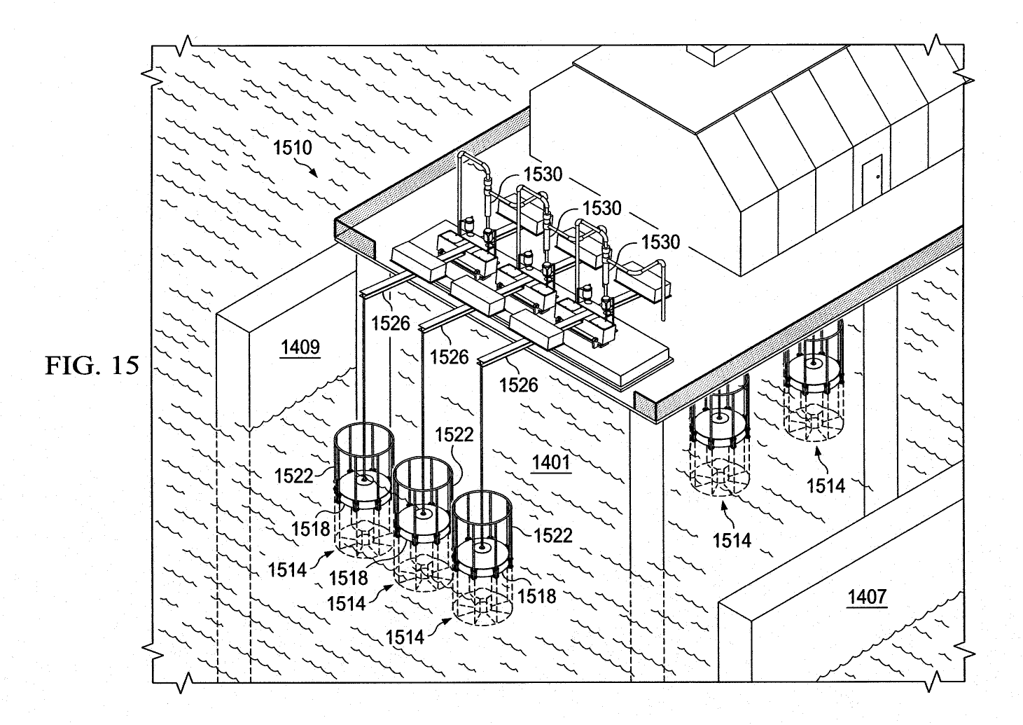

Referring to FIG. 15 as a further example, an offshore platform 1510 is positioned within the vertical walls 1407, 1409 of the tank 1401 in a body of water. The offshore platform 1510 incorporates a wave capture system 1514 similar to that described. While the energy transfer system 100 and wave capture system 900 were each described previously as being used in a tank of liquid, any of the systems described herein may be used in open bodies of water such as the ocean, large or small lakes, estuaries, ponds, or other collections of water. The offshore platform 1510 illustrated in FIG. 15 includes several of the wave capture systems 1514. Each of a buoyancy block 1518 is positioned within a buoyancy cage 1522 that assists in minimizing lateral movement of the buoyancy block 1518 as the buoyancy block 1518 rises and falls with the waves. The buoyancy blocks 1518 are each connected to a transfer arm 1526 to drive a piston assembly 1530 such that liquid may be pumped to impart mechanical energy to the fluid. The structure and operation of the wave capture systems 1514 is similar to the wave capture system 900. The offshore platform 1510 may also include buoyancy pump systems 1540 that are capable of pumping liquid to generate electricity or perform other functions.

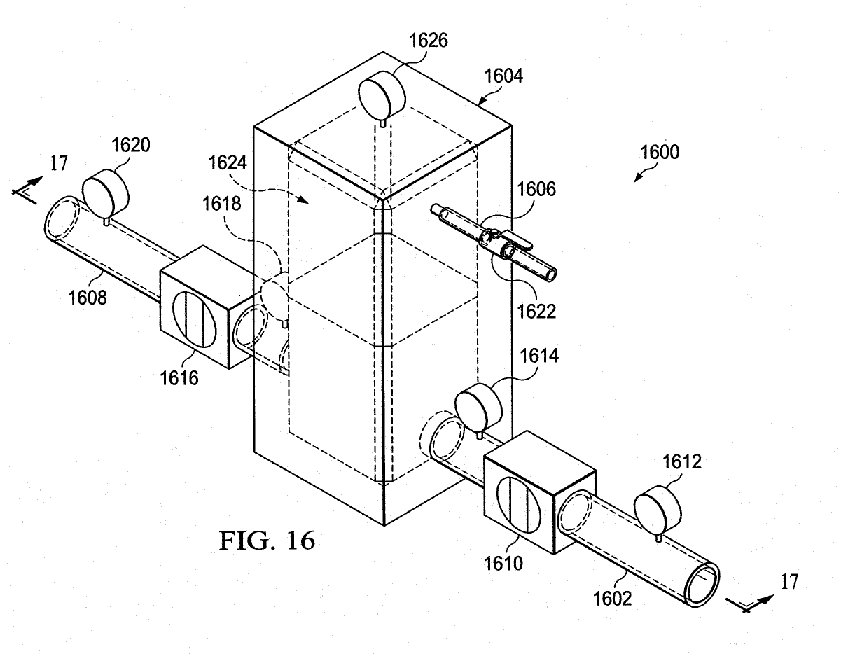

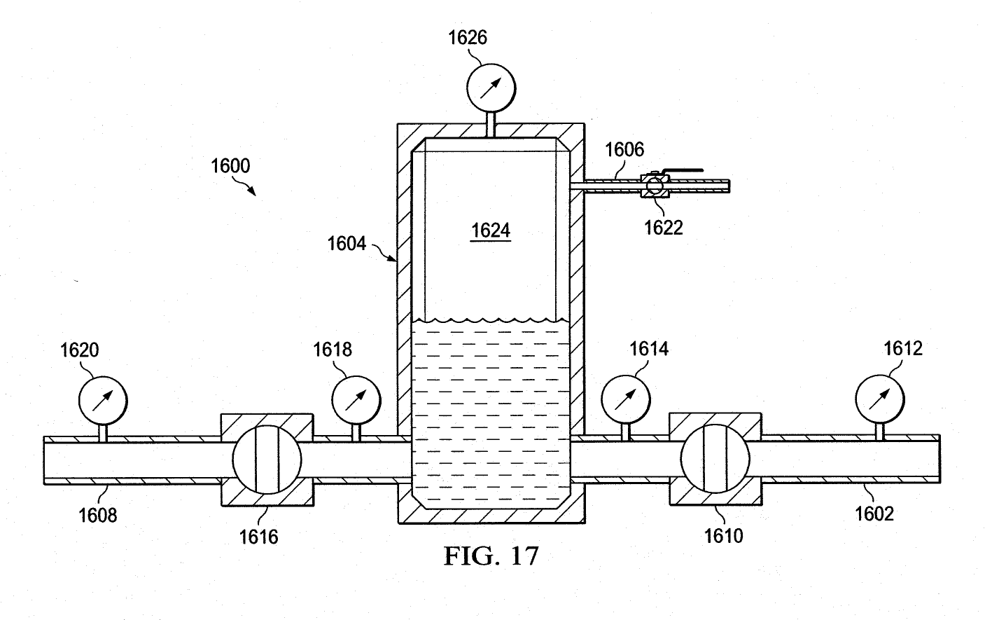

Referring now primarily to FIGS. 16-21, and initially to FIGS. 16-17, several embodiments of an artificial head are presented. An artificial head 1600 of FIGS. 16-17 may receive fluid from a fluid source, such as the wave capture system 900 illustrated in FIG. 9. The artificial head 1600 is operable to store and deliver fluid received from the wave capture system to a reservoir (not shown), a hydro-electric turbine, or other uses. The artificial head 1600 includes an intake conduit 1602 fluidly connected to the fluid source. In one embodiment, the fluid is received from the wave capture system 900 and may be another type of fluid other than water. The artificial head 1600 further includes a pressure vessel 1604 for receiving and possibly storing water received from the intake conduit 1602 for a period of time. The pressure vessel may contain a combination of liquid and gas. In some embodiments, a gas pressure conduit 1606 fluidly connects the pressure vessel 1604 to an air compressor (not shown) for pressurizing the pressure vessel 1604. The artificial head 1600 further includes an output conduit 1608 fluidly connected to the reservoir. The artificial head 1600 is operable to deliver the water to the reservoir by way of the output conduit 1608.

While reference is made to the artificial head 1600 delivering water to a reservoir, the artificial head 1600 may be further operable to deliver water to a number of mechanical devices that run on high pressure water flows, including, but not limited to, hydro-turbines. Additionally, the artificial head 1600 may deliver the water to water towers, elevated reservoirs, over a dam, or other desired locations or uses.

The intake conduit 1602 may include an intake control valve 1610 for adjusting the flow of water into the pressure vessel 1604. The intake control valve 1610 may be adjusted manually, mechanically, or electronically. Pressure gauges 1612 and 1614 may be positioned on the intake conduit 1602 on either side of the of the intake control valve 1610. The pressure gauges 1612, 1614 may monitor the pressure and flow rate of water entering the pressure vessel 1604. The data provided by the pressure gauges 1612, 1614 may be used to determine whether adjustments need to be made to the pressure and flow rate of the water entering the pressure vessel 1604 by adjusting the intake control valve 1610.

The output conduit 1608 includes an output control valve 1616 for adjusting the flow of water out of the pressure vessel 1604. The output control valve 1616 may be adjusted manually, mechanically, or electronically. Pressure gauges 1618 and 1620 may be positioned on the output conduit 1608 on either side of the of the output control valve 1616. The pressure gauges 1618, 1620 may monitor the pressure and flow rate of water exiting the pressure vessel 1604. The data provided by the pressure gauges 1618, 1620 may be used to determine whether adjustments need to be made to the pressure and flow rate of the water exiting the pressure vessel 1604 by adjusting the output control valve 1616.

As previously mentioned, the pressure vessel 1604 may be connected to a gas pressure conduit 1606, which is fluidly connected to the air compressor (not shown) for pressurizing the pressure vessel 1604. A pressure gauge 1626 may be positioned on the pressure vessel 1604 to monitor the pressure within the pressure vessel 1604. A gas pressure control valve 1622 may be connected to the gas pressure conduit 1606 for allowing gas to be periodically introduced into the pressure vessel 1604 by the air compressor. The pressure vessel 1604 is a variable pressure vessel. The air compressor is operable to deliver pressurized air to the pressure vessel 1604 to a desired pressure. The desired pressure level in the pressure vessel 1604 depends on the desired pressure, flow rate, and head of the water exiting the output conduit 1608. The gas pressure control valve 1622 allows the introduction or removal of gas to the pressure vessel 1604 in order to increase or lower the pressure within the pressure vessel 1604.

The artificial head 1600 further includes a pressurized gas cap 1624 within the pressure vessel 1604 that stabilizes the water flow received from the wave system. The pressurized gas cap 1624 causes the water output leaving the pressure vessel 1604 to exit with a more stable pressure and flow, relative to the input flow.

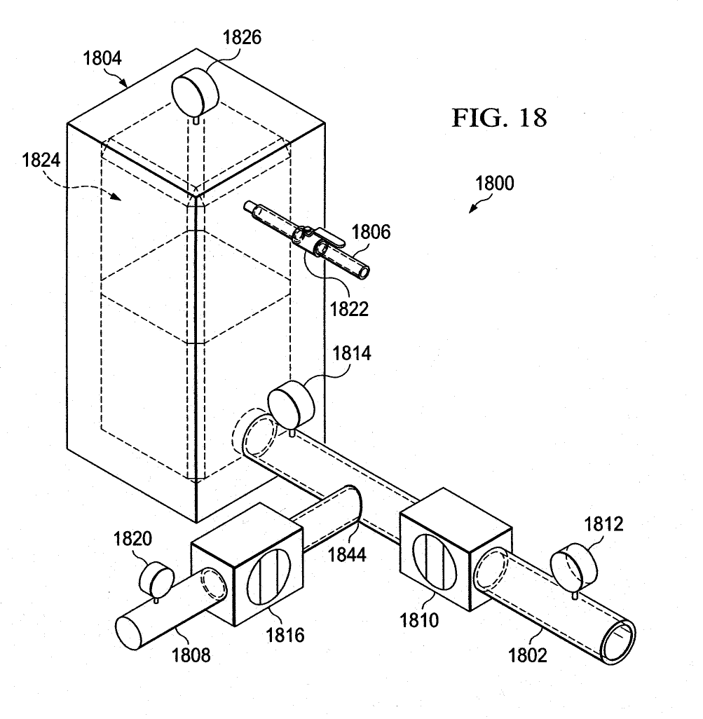

Referring now primarily to FIG. 18, another illustrative embodiment of an artificial head 1800 is presented. The artificial head 1800 is similar to the artificial head 1600 presented in FIG. 16 except the artificial head 1600 is configured such that all the liquid enters the pressure vessel 1604 via the intake conduit 1602 and exits the pressure vessel 1604 via the output conduit 1608. The artificial head 1800 illustrated in FIG. 18, is configured such that the liquid enters a pressure vessel 1804 until the pressure of a pressurized gas cap 1824 that exists within the pressure vessel 1804 prevents any more water from entering the pressure vessel 1804 through an intake conduit 1802. The pressure vessel 1804 may include a pressure gauge 1826. Once liquid is prevented from entering the pressure vessel 1804, the liquid is diverted and directed through an output conduit 1808. The liquid is diverted from entering the pressure vessel 1804 because the pressurized gas cap 1824 stabilizes the pressure within the intake conduit 1802 and the incoming liquid flow shears at an intersection 1844 of the intake and output conduits 1802, 1808. The artificial head 1800 further includes a number of pressure gauges, control valves and a gas pressure conduit 1806. Pressure gauges 1812 and 1814 are positioned on the intake conduit 1802 on either side of an intake control valve 1810. Additionally, an output control valve 1816 is positioned on the output conduit 1808 as well as a pressure gauge 1820. The output control valve 1816 is positioned on the output conduit 1808 between the pressure gauge 1820 and the intersection 1844. In some embodiments, the gas pressure conduit 1806 provides fluid communication between an air compressor and the pressure vessel 1804. Additionally, a gas pressure control valve 1822 may be positioned on the gas control line. The pressure gauges 1812, 1814, 1820, and 1826; the control valves 1810, 1816, and 1822; and the gas pressure conduit 1806 function similarly to the pressure gauges 1612, 1614, 1618, 1620 and 1626; the control valves 1610, 1622, and 1616; and the gas pressure conduit 1606 of FIG. 16.

The artificial heads 1600 and 1800 may be used to move large volumes of water to an elevated reservoir. For example, in the instance water is being moved by the head to an elevated reservoir, the pressure vessel may be filled with water to approximately two-thirds (⅔) of its volume, the input valve closed and the gas cap pressurized to a pressure greater than three times the pressure necessary for the desired lift or elevation. The output control valve on the output conduit may then be opened. Water is then moved under pressure to the desired destination or elevation.

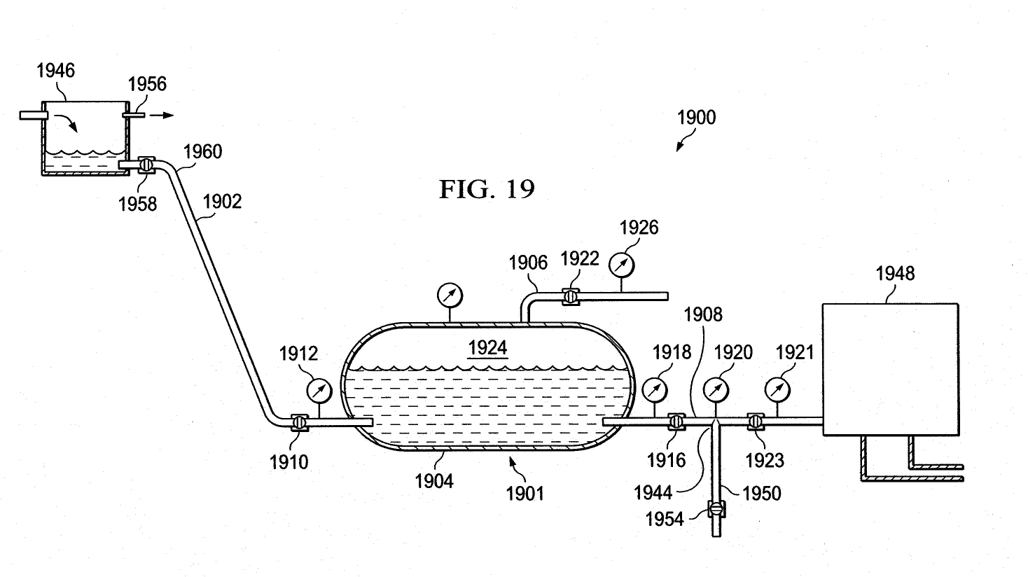

Referring now to FIG. 19, an illustrative embodiment of an artificial head system 1900 is presented. The system 1900 illustrates a micro-scale hydro storage electric plant which is operable to produce on-demand energy output. The system 1900 may be used in locations such as a creek, small stream, or where a significant elevation drop exists. Such locations as described typically do not have sufficient land area available to for a dam or water reservoir to be a practical mechanism for energy production. Additionally, such locations may not have water flow rates sufficient to justify the cost of a large scale hydro-power plant. Thus, the micro-scale head system 1900 presents advantages over other hydro electric plants.

The system 1900 includes an artificial head 1901, an intake conduit 1902 connected to the artificial head 1901 operable to deliver water from a water source 1946 to the artificial head 1901. The intake conduit 1902 may direct water flow, or a portion of the water flow, from an elevated water source 1946 downhill to a pressure vessel 1904. The water source 1946 may be a catchment basin or a slue and may include an overflow conduit 1956 or a spillway. The pressure vessel 1904 may be connected to a hydro turbine 1948 through an output conduit 1908. Alternatively, or in combination with the hydro turbine 1948, the pressure vessel 1904 may further be connected to a second output conduit 1950 that directs or diverts the water to a second destination (not shown). The second destination may be, but is not limited to, a reservoir, a water processing unit, irrigation, or a secondary turbine. As illustrated, the second output conduit 1950 is connected to the output conduit 1908. The second output conduit 1950 may form a T-junction with the output conduit 1908. In one embodiment, the T-junction is a Y-junction or another multi-flow connector.

Similar to the artificial heads 1600 and 1800, the artificial head 1901 includes a number of gauges and control valves and may include a gas pressure conduit 1906 fluidly connected to an air compressor (not shown). For example, a pressure gauge 1912 and control valves 1910 and 1958 are positioned on the intake conduit 1902. The first control valve 1910 may be positioned proximate the pressure vessel 1904 and the second control valve 1958 may be positioned proximate the water source 1946. The output conduit 1908 may include pressure gauges 1918, 1920, and 1921 and control valves 1916 and 1923. The pressure gauge 1918 and the control valve 1916 may be positioned on the output conduit 1908 between the pressure vessel 1904 and the T-junction connecting the output conduit 1908 and the second output conduit 1950. The pressure gauge 1920 may be positioned at the T-junction. And, the pressure gauge 1921 and the control valve 1923 may be positioned between the T-junction and the hydro turbine 1948. The second output conduit 1950 may also includes a control valve 1954. The gas pressure conduit 1906 may include a control valve 1922 and pressure gauge 1926. The pressure gauges and control valves function similar as described above with reference to FIGS. 16-18.

The intake conduit 1902 may further include a penstock 1960. The diameter of the penstock 1960 may be determined primarily by the flow rate available from the water source 1946 and the length of the penstock 1960 may be determined by the elevation differential (distance) between the water source 1946 and the pressure vessel 1904. It is worth noting that while the head is irrelevant to the size of the pressure vessel 1904, the head is highly relevant to the pressure-rating of the pressure vessel 1904 and the hydro turbine 1948 used.

The configuration of the system 1900, including the size and shape, may be dependent on the amount of water storage desired, the available flow rate diverted from the water source, the elevation difference between the artificial head 1901 and the water source, and the hydro turbine's discharge rate for a given time period.

In a specific, non-limiting example, the operation of the system 1900 may be described as follows. The system 1900 may be connected to the water source 1946 having an available 10 gallon per minute flow rate where 5 gallons per minute are diverted for the system's 1900 usage. The water flowing at 5 gallons per minute is delivered to the pressure vessel 1904 having, for example, a 10,000 gallon usable capacity via the intake conduit 1902. Once the pressure vessel 1904 has been filled to two-thirds (⅔) capacity, taking approximately 1333 minutes, water would no longer be diverted from the water source 1946 to the system 1900. The first control valve 1910 located in the intake conduit 1902 may be closed or a mechanism at the water source may prevent water from entering the intake conduit 1902. Once the pressure vessel 1904 has been filled, the pressure vessel may be pressurized by injecting gas and the water may be discharged to the hydro turbine 1948. Alternatively, air trapped in the pressure vessel 1904 may become pressurized as water fills the pressure vessel 1904 and compresses the trapped air. The discharged water from the hydro turbine 1948 could be delivered to a lower reservoir to make further use of the liquids potential energy.

In another specific, non-limiting example, the operation of the system 1900 may be described as follows. The pressure vessel 1904 would be empty and would need to be charged using an air compressor to the appropriate pressure calculated as one-third (⅓) of the maximum linear head delivered by the penstock 1960 measured in linear feet above the pressure vessel 1904. To charge the pressure vessel 1904, the control valves 1916, 1954, and 1923 in the output conduits 1908, 1950 will be closed. The water captured in the water source 1946 flows past the control valve 1958, down the intake conduit 1902, into the penstock 1960, through the first control valve 1910 adjacent the pressure vessel 1904, into the pressure vessel 1904 and out to the control valve 1916, which is closed. The control valve 1916 blocks the water from passing and causes the pressure vessel 1904 to fill. As the pressure vessel 1904 fills with water, air trapped in the pressure vessel 1904 compresses and creates a pressurized gas cap 1924. Once the pressure within the pressure vessel 1904 rises to a pre-determined pressure, via liquid flowing into the pressure vessel 1904, the system 1900 reaches its charged state (water fills to approximately two-thirds (⅔ ) of the maximum volume of the pressure vessel 1604). The pressurized gas cap 1924 will prevent any more water from entering the pressure chamber because pressure within the pressure vessel 1604 is equal to that of the linear head of the water elevation drop. The water will have filled the penstock 1960. Eventually, water will stop flowing into the intake conduit 1902 and the water from the stream or creek will flow normally. At this point, the system 1900 is fully charged. At any point after filling has begun, it is possible to release the stored energy. Furthermore, at any point during the release of the stored energy, it is possible to begin storing energy again.

In order to produce mechanical power, the system 1900 is discharged. The system 1900 is discharged by opening the closed flow control valves 1916 and 1923 between the pressure vessel 1904 and the turbine 1948.

In yet another illustrative embodiment, multiple pressure vessels may be utilized. The multiple pressure vessels may run independently of each other or may be connected to perform multiple tasks simultaneously, as a group or independently.

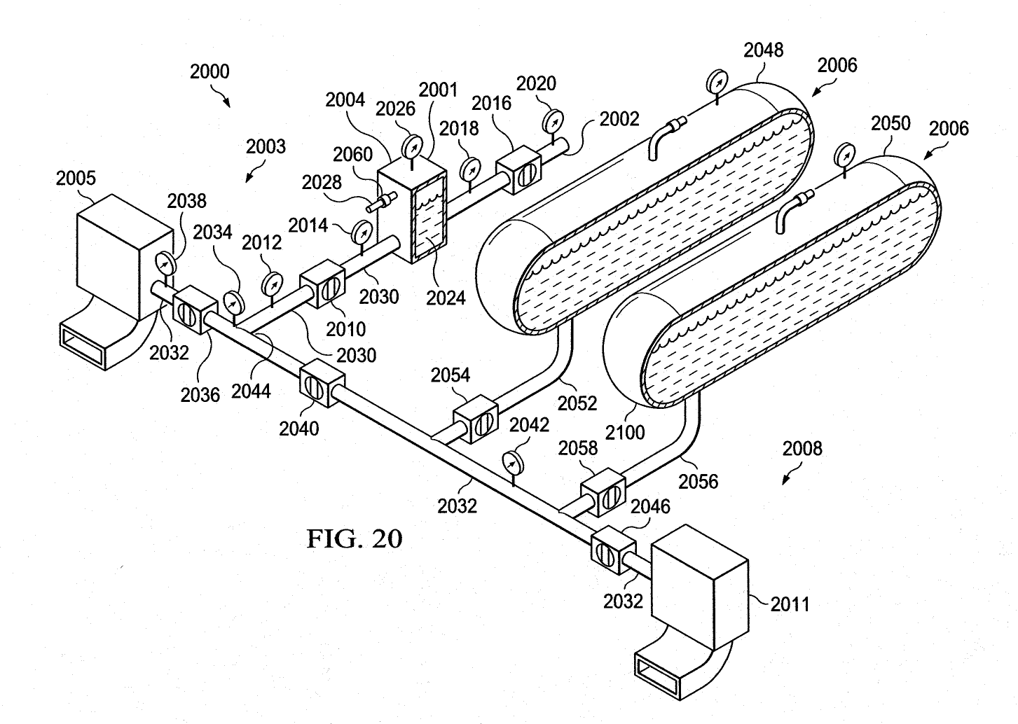

Referring now primarily to FIG. 20, another embodiment of an artificial head system 2000 is presented. The system 2000 is configured to allow for both dynamic and stable water flow while providing an accompanying energy storage system. The system 2000 includes an artificial head 2001 connected to a first side 2003, or a high pressure side, and a second side 2008, or a low pressure side, of the system.

The artificial head 2001 receives liquid through an intake conduit 2002 from a high-pressure liquid source, such as the wave capture system 900 illustrated in FIG. 9. The intake conduit 2002 includes a control valve 2016 and pressure gauges 2020 and 2018. The artificial head 2001 stabilizes the water flow received by the high-pressure water source and directs the stabilized water flow to a high-pressure turbine 2005, or alternatively to at least one storage tank 2006 positioned on the second side 2008 of the system. The artificial head 2001 includes a pressurized gas cap 2024, a pressure gauge 2026 and may be fluidly connected to an air compressor through a gas pressure conduit 2028. A control valve 2060 may be positioned on the gas pressure conduit 2028. The artificial head 2001 is connected to the first and second side 2003, 2008 through an output conduit 2030. The output conduit 2030 may include a control valve 2010 and pressure gauges 2012, 2014 on either side of the control valve 2010.

The output conduit 2030 is connected to a conduit 2032 that extends from the first side 2003 to the second side 2008. In one embodiment, the output conduit 2030 intersects the conduit 2032 to form a T-junction 2044, or intersection. The conduit 2032 has several control valves and pressure gauges. The conduit 2032 may include a pressure gauge 2034 positioned at the T-junction 2044. On the high pressure side 2003, between the junction 2044 and the turbine 2005, the conduit 2032 further includes a control valve 2036 and a pressure gauge 2038 positioned between the control valve 2036 and the turbine 2005. On conduit 2032 between the high-pressure side 2003, and the low-pressure side 2008, is a control valve 2040 isolating the two systems. As shown, the storage tanks 2006 include a first storage tank 2048 and a second storage tank 2050. A first tank conduit 2052 fluidly connects the first storage tank 2048 to the conduit 2032. A control valve 2054 is positioned on the first tank conduit 2052. Additionally, a second tank conduit 2056 fluidly connects the second storage tank 2050 to the conduit 2032. The second tank conduit 2056 includes a control valve 2058. A pressure gauge 2042 may be positioned on the conduit 2032 between where the first and second tank conduits 2052, 2056 intersect the conduit 2032. The conduit 2032 further includes a control valve 2046 positioned on the conduit 2032 between a low-pressure hydro turbine 2011 and the intersection of the second tank conduit 2056 and the conduit 2032.

Each of the storage tanks 2006 may include at least one pressure gauge and may be connected to an air compressor with the appropriate control valves. While two storage tanks are shown, 2048 and 2050, any number of storage tanks may be employed.

The second side 2008, or the low pressure side, of the system 2000 stores pressurized water for use on-demand or during peak demand times. The low-pressure side 2008 includes the storage tanks 2006 and the low-pressure hydro turbine 2011. Water from the low-pressure side 2008 is delivered from the storage tanks 2006 to the low-pressure hydro turbine 2011.

The low-pressure side 2008 and the high pressure side 2003 of the system 2000 work in conjunction to allow constant production of power via the turbines 2005, 2011, while storing unneeded energy in the storage tanks 2006 for recovery at a later time.

In a specific, non-limiting example, the system 2000 operates as follows. The system 2000 begins with an initial start-up. A complete absence of water in the system 2000 is assumed. For this example, the turbine 2005 on the high-pressure side 2003 operates at 600 psi and the turbine 2011 on the low-pressure side 2008 operates at 200 psi. Prior to initially charging the system 2000, all the flow control valves would be in an open position, with the exception of the control valves 2016, 2036, and 2046. A gas pressure control valve 2022 associated with a pressure vessel 2004 and the pressure control valves associated with the storage tanks 2006 should be placed in the open position. At this point, the system 2000 is ready to be primed with liquid (barely filled). This is accomplished by opening the control valve 2016 and allowing water to be delivered to the conduit 2032 by first passing through the pressure vessel 2004 and the output conduit 2030. The closed control valves 2036 and 2046 will prevent the water from draining out through the turbines prematurely. Liquid will then flow into the first and second storage tank conduits 2052, 2056. Once the first and second storage tank conduits 2052 and 2056 have been completely filled, the control valve 2016 is closed to stop water from entering the system. Next, the gas pressure control valve 2022 associated with the pressure vessel 2004 and the pressure control valves associated with the storage tanks 2006 should be placed in the closed position. At this point the system 2000 is primed with water and is now ready to be primed with pressurized air.

The system 2000 receives a one time external pressurization process (although the pressurization process may be required again if a leak develops of depressurization was required). The flow control valves 2010, 2054, and 2058 are closed. The pressure vessel 2004 and each of the storage tanks 2006 are pressurized to 200 psi. The flow control valves 2010, 2054, and 2058 are then opened.

Once the flow control valves 2010, 2054, and 2058 are opened, the flow control valve 2016 is opened allowing water to be delivered to the system 2000 until the pressure vessel 2004 and the storage tanks 2006 are charged to a pressure of 600 psi. Once the pressure vessel 2004 and the storage tanks 2006 are charged, the control valve 2040 is closed and the control valve 2036 adjacent the turbine 2005 is opened. At this point, high pressure water will be forced through the high-pressure turbine 2005 at 600 psi and mechanical energy will be produced. While the control valve 2040 leading to the low pressure side is closed, water is fed to the turbine 2005 and the low-pressure side 2008 is static.

To utilize the low-pressure side 2008, the control valve 2046 adjacent the low-pressure turbine 2011 is opened and pressurized liquid from the storage tanks 2006 will be forced through the turbine 2011. Once the storage tanks 2006 become discharged down to 200 psi, the low-pressure side 2008 turbine 2011 is shut down by closing control valve 2046 and will no longer produce mechanical energy until the low pressure side 2008 has been recharged at least partially.

To recharge the low-pressure side 2008, the control valves 2046 and 2036 adjacent the high and low-pressure turbines 2005 and 2011 are closed and the control valve 2040 is opened. As water is diverted to the storage tanks 2006, the low-pressure side 2008 again is being recharged.

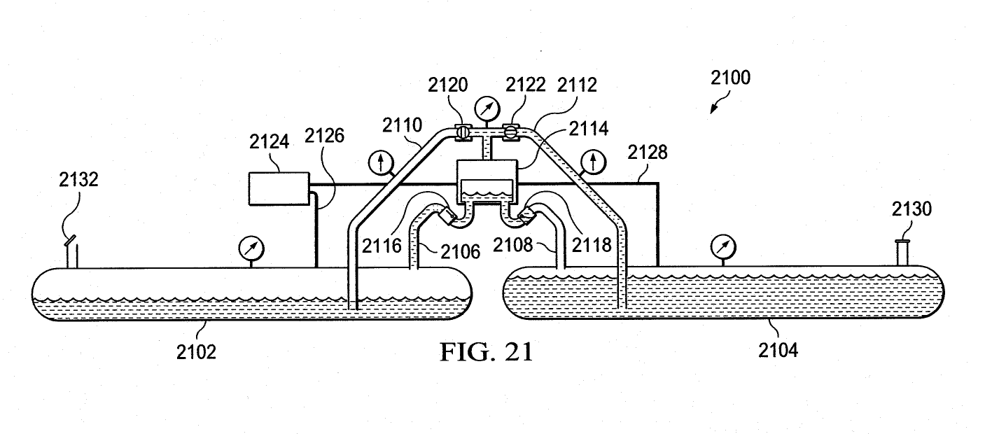

Referring now primarily to FIG. 21, another embodiment of a head system 2100 is presented. The system 2100 is a closed loop gas or air driven energy storage unit. The system 2100 includes at least two storage tanks 2102, 2104 that are fluidly connected by inlet conduits 2106, 2108 and outlet conduits 2110, 1212 through a hydro turbine 2114. The inlet conduits 2106, 2108 and the outlet conduits 2110, 2112 each have one or more control valves, such as the control valves 2116, 2118, 2120, 2122. In one embodiment, the outlet conduits 2110, 2112 are positioned proximate a bottom portion of the respective storage tanks 2102, 2104 to maximize the amount of fluid stored in the tanks 2102, 2104 to be discharged or exchanged. Fluid is transferred from the first tank 2102 to the second tank 2104 through the hydro turbine 2114. Both the first and second storage tanks 2102 and 2104 are connected to an air compressor 2124 through gas pressure conduits 2126 and 2128. The air compressor pressurizes the tanks 2102 and 2104 to a desired pressure. The pressurization of the tanks 2102 and 2104 creates the pressure or driving force needed during the liquid exchange between the tanks 2102 and 2104 when the compressor is not operating. As an example, when charged, the water volume in a tank may be approximately two-thirds (⅔) of the total volume of the tank and the pressure in the tank is approximately three times the hydro turbine's 2114 desired inlet pressure. Using these volume and pressure parameters creates pressure stabilization and allows for water or fluid to be delivered to the hydro turbine 2114 during the fluid exchange at the appropriate pressure and flow volume.

While FIG. 21 illustrates two storage tanks 2102, 2104, it should be understood that the system 2100 may range from two to thousands of storage tanks having a capacity of a few to hundreds of thousands of gallons depending on the desired storage capacity and delivery rate. Multiple storage tank systems, or “hydro storage farms” may be arranged such that they are piped together with check and control valve systems that provide monitoring and control of all fluid and gas/air stored for mechanical energy production through one or multiple hydro turbines

In a specific, non-limiting example of the system's 2100 operation, the first tank 2102 is charged, meaning the first tank 2102 is filled with water to approximately three-fourths (¾) of the tank volume and is pressurized to four times the hydro turbine's 2114 desired inlet pressure. The second tank 2104 is discharged, meaning the tank is virtually empty of water and the pressurized air has been released through a vent 2130. The first tank 2102 is then discharged through the outlet conduit 2110 to the hydro turbine 2114. The hydro turbine 2114 converts the flow of pressurized water received from the first tank 2102 into mechanical energy. The mechanical energy can be used to produce electricity. The water is then discharged from the hydro turbine 2114 through the inlet conduit 2108 into the second tank 2104. Once the second tank 2104 has been filled with the discharge from the hydro turbine 2114, then the second tank 2104 is pressurized similar to how the first tank 2102 was pressurized. The process is then repeated. It should be understood the system may operate using a number of different fluids and that the term fluid may include liquids or gases, to include steam.

In an alternative embodiment, a steam driven artificial head system utilizing a similar system as system 2100 may be used but without a compressor. The steam system heats the liquid in one of the tanks to the boiling point such that steam is released from the liquid, pressurizing the tank for discharge (rather than using a gas/air compressor to pressurize the system). The steam system may require an external liquid source to maintain the desired liquid levels as some loss of liquid may result through evaporation.

With general reference to FIGS. 16-21, the gauges and valves described may be used to monitor various aspects of the system. The gauges and valves may be manual, semi-automatic, fully automatic, or a combination in operation. The data from the gauges and valves may be used to control the systems or devices and may be used to determine the stages of operation.

In a specific, non-limiting example, the valves may be comprised of check valves, directional valves, pressure regulation valves, shut-off valves, and flow control valves. The valves may be controlled manually, mechanically, electronically, pneumatically, and hydraulically. One should appreciate that there are a number of ways to control the valves.

In one embodiment the inlet conduits of an artificial head, such as the intake conduits 1602, 1802, and 1902 should be connected to the bottom of the respective pressure vessel such that the inlet conduit is level with the bottom of the pressure vessel to maximize utilization of the storage capabilities of the pressure vessels. Typically, the optimal fill volume for all artificial heads will be between 66% and 75% of the total volume of the pressure vessel. The air in the remaining 25% to 33% of the total volume of the pressure vessel should be pressurized to a minimum of three times the pressure needed to either deliver or operate the mechanism receiving the water from the pressure vessel. As previously described, mechanisms that receive the water may include, but is not limited to, a hydro turbine, reservoir, or even an elevated water reservoir.

It should be further noted that a number of the artificial heads disclosed are ripe for use in existing municipal water supply systems that utilize water towers. Water towers are expensive to construct and maintain. Thus, an artificial head which could be described as an artificial head tank may replace water towers. The head tank may be located at ground level or be buried below grade. In an illustrative, non-limiting embodiment, a 300,000 gallon capacity artificial head tank could be constructed and connected to a continuous inbound water supply line. The tank is filled to approximately two-thirds (⅔) the maximum volume of the tank and will deliver outbound water to a delivery system at usable pressure of between 30 and 50 pounds per square inch (psi) by maintaining a pressurized gas cap of three times the desired delivery pressure and regulating the outbound pressure to the desired range. In this embodiment, the gas cap pressure will be maintained at 90-150 psi. In an alternate embodiment, the gas cap pressure is kept between 30 and 50 psi by utilizing an air compressor to add pressure and bleeding off excess pressure as needed.

In a further non-limiting illustration, using a 300,000 gallon capacity artificial head tank in conjunction with a smaller 30,000 gallon capacity artificial head tank allows the two tanks to deliver a constant supply of water to a municipality from a low pressure source such as a river. One example of how this could be done is as follows. Fill the non-pressurized head tanks and then pressurize them to optimal working pressures. The larger tank is filled without any pressure in the pressure vessel to 67.5% volume capacity and then charged with gas/air through a pressurized gas control line to three times the required working pressure of 30-50 psi (or 90-150 psi), bringing the tanks online for water flow. While the larger tank is online, the smaller tank is filled with water to 67.5% capacity without pressure in the pressure vessel, then air/gas is injected into the pressurized air chamber to three times the required working pressure of 30-50 psi (or 90-150 psi). The smaller head tank is now charged and will go online supplying water to the mainline, replacing the larger artificial head tank for supplying water to the mainline so the larger tank can shut down and recharge. The larger tank is then de-pressurized by releasing the remaining air out of the gas/air control valve. Then, the fill process is repeated, the air vent is closed and the variable pressure gas chamber is pressurized to the desired pressure going back online to supply the main waterline. The smaller tank is then taken offline to recharge and process begins again as needed to maintain a constant flow for end users. In one embodiment, a pressure control valve can be added to the outbound line to ensure a stable water pressure to the municipality. An end user may, for example, be an office building or a housing tract. The tanks for water delivery are connected to and fed by the main feed waterline operating at low pressure.

Similar applications exist for moving significant amounts of water for agricultural, ranching, and industrial water needs.

The previous description is of preferred embodiments for implementing the invention, and the scope of the invention should not necessarily be limited by this description. The scope of the present invention is instead defined by the following claims.

1.-30. (canceled)

31. An energy transfer system comprising:
a tank filled with liquid;
a transfer arm pivotally attached to the tank to allow pivotal movement of the transfer arm between an engaged position and a disengaged position, the transfer arm having a first end and a second end;
a displacement block partially submerged in the water and coupled to the first end of the transfer arm, the displacement block being operable to oscillate between the engaged position and the disengaged position;
a first spring member operably associated with the transfer arm to exert a first force on the transfer arm when approaching the engaged position;
a second spring member operably associated with the transfer arm to exert a second force on the transfer arm when approaching the disengaged position, the first force being substantially opposite in direction to the second force;
an input source coupled to the second end of the transfer arm to move the transfer arm between the engaged position and the disengaged position;
a first buoyancy block positioned in the tank and operable to reciprocally move in response to the waves in the tank; and
a piston and a piston cylinder wherein the piston is slidably disposed within a piston cylinder and connected to the first buoyancy block, the piston being reciprocally movable in a first direction to draw an operating fluid into the piston cylinder and in a second direction to force the operating fluid out of the piston cylinder.

32. The system of claim 31, further comprising a cylindrical cage connected to the tank and having a chamber within which the first buoyancy block moves.

33. The system of claim 31, further comprising a rectangular cage connected to the tank and having a chamber within which the first buoyancy block moves.

34. The system of claim 31, wherein the first buoyancy block is substantially rectangular having a length substantially equal to the width of the tank.

35. The system of claim 31, wherein the input source comprises a force generation mechanism selected from a group consisting of pneumatic, hydraulic, mechanical, and electric systems.

36. The system of claim 31, wherein the system further comprises a power source for energizing the input source.

37. The system of claim 31, wherein the system further comprises a first counterweight coupled to the first end of the transfer arm whereby the input source requires less energy to move the transfer arm.

38. The system of claim 37, wherein the system further comprises a second counterweight coupled to the second end of the transfer arm whereby the transfer arm is balanced between the engaged position and the disengaged position.

39. The system of claim 31, wherein the displacement block is generally rectangular in shape.

40. The system of claim 31, wherein the displacement block is substantially bell-shaped.

41. The system of claim 31, wherein the first spring member and the second spring member each comprise a pair of magnets with each magnet oriented such that like poles of the magnets face one another.

42. The system of claim 41, wherein the magnets of the first spring member are closest together when the transfer arm is proximate the engaged position.

43. The system of claim 41, wherein the magnets of the second spring member are closest together when the transfer arm is proximate the disengaged position.

44. The system of claim 31, wherein the tank is generally rectangular in shape and the displacement block is generally rectangular in shape and position proximate one end of the tank, and wherein the first buoyancy block is located at a position other than that end of the tank.

45. The system of claim 31, wherein the tank is generally circular in shape and the displacement block is generally bell-shaped and positioned near the center of the tank, and wherein the first buoyancy block is located at a radial position other than the center of the tank.

46. The system of claim 45, wherein the first buoyancy block and “a plurality of buoyancy blocks similar to the first buoyancy block are located circumferentially around the displacement block.

47. The system of claim 31, wherein the tank is generally cross-shaped having four leg portions and the displacement block is generally square-shaped and positioned near the center of the tank, and wherein the first buoyancy block is located at a position in one of the legs of the tank.

48. The system of claim 47, further comprising three buoyancy blocks similar to the first buoyancy block located in the other three legs of the tank.

49. The system of claim 31, wherein the tank is generally Y-shaped having a stem portion and two leg portions and the displacement block is positioned in the stem portion of the tank, the first buoyancy block positioned in one leg portion of the tank, and a second buoyancy block positioned in the other leg portion of the tank.

50. The system of claim 31, wherein the tank is generally Y-shaped having a stem portion and two leg portions and the first buoyancy block is positioned in the stem portion of the tank, the displacement block positioned in one leg portion of the tank, and a second displacement block positioned in the other leg portion of the tank.

51. The system of claim 31, wherein the displacement block is oscillated at a frequency that generates a standing wave pattern within the tank.

52. An energy transfer system comprising:
a tank filled with liquid;
a displacement block partially submerged in the water, the displacement block being operable to oscillate between the engaged position and the disengaged position, where the displacement of the block is greater in the engaged position than the disengaged position
an input source coupled to the displacement block to move the displacement block between the engaged position and the disengaged position; and
a wave capture apparatus operable to respond to the waves in the tank to generate an output.

53. An energy transfer system comprising:
a tank filled with liquid;
a first transfer arm pivotally attached to one end of the tank to allow pivotal movement of the first transfer arm between an engaged position and a disengaged position, the first transfer arm having a first end and a second end;
a displacement block partially submerged in the water and coupled to the first end of the first transfer arm, the displacement block being operable to oscillate between the engaged position and the disengaged position;
a first spring member operably associated with the first transfer arm to exert a first force on the first transfer arm when approaching the engaged position;
a second spring member operably associated with the first transfer arm to exert a second force on the first transfer arm when approaching the disengaged position, the first force being substantially opposite in direction to the second force;
an input source coupled to the second end of the first transfer arm to move the first transfer arm between the engaged position and the disengaged position; and
a wave capture apparatus operable to respond to the waves in the tank to generate an output.

54. The system of claim 53, wherein the wave capture apparatus comprising:
a buoyancy block operable to reciprocally move in response to the waves in the tank when submerged in the liquid;
a second transfer arm pivotally attached to the tank to allow pivotal movement of the second transfer arm between a first position and a second position, the second transfer arm having a first end and a second end, the first end being coupled to the buoyancy block whereby movement of the second transfer arm between the first position and the second position is in response to movement of the buoyancy block;
a third spring member operably associated with the second transfer arm to exert a third force on the second transfer arm when approaching the first position;
a fourth spring member operably associated with the second transfer arm to exert a fourth force on the second transfer arm when approaching the second position, the third force being substantially opposite in direction to the fourth force; and
an output source coupled to the second end of the second transfer arm and operable to reciprocally move in a first direction and a second direction.

54. An energy transfer system comprising:
a tank filled with liquid;
a first transfer arm pivotally attached to one end of the tank to allow pivotal movement of the first transfer arm between an engaged position and a disengaged position, the first transfer arm having a first end and a second end;
a displacement block partially submerged in the liquid and coupled to the first end of the first transfer arm, the displacement block being operable to oscillate between the engaged position and the disengaged position;
a first spring member operably associated with the first transfer arm to exert a first force on the first transfer arm when approaching the engaged position;
a second spring member operably associated with the first transfer arm to exert a second force on the first transfer arm when approaching the disengaged position, the first force being substantially opposite in direction to the second force;
an input source coupled to the second end of the first transfer arm to move the first transfer arm between the engaged position and the disengaged position;
a buoyancy block operable to reciprocally move in response to the waves in the tank when submerged in the liquid;
a second transfer arm pivotally attached to the tank to allow pivotal movement of the second transfer arm between an first position and a second position, the second transfer arm having a first end and a second end, the first end being coupled to the buoyancy block whereby movement of the second transfer arm between the first position and the second position is in response to movement of the buoyancy block;
a third spring member operably associated with the second transfer arm to exert a third force on the second transfer arm when approaching the first position;
a fourth spring member operably associated with the second transfer arm to exert a fourth force on the second transfer arm when approaching the second position, the third force being substantially opposite in direction to the fourth force; and
an output source coupled to the second end of the second transfer arm and operable to reciprocally move in a first direction and a second direction.

55.-107. (canceled)
